(19) United States
(12) Patent Application Publication
(10) Pub. No.: US 2022/0012750 A1
(43) Pub. Date: Jan. 13, 2022

(54) SYSTEMS AND METHODS FOR VENDOR EXCHANGE MANAGEMENT

(71) Applicant: Venminder, Inc., Elizabethtown, KY (US)

(72) Inventor: Dana A. Bowers, Elizabethtown, KY (US)

(21) Appl. No.: 17/365,552

(22) Filed: Jul. 1, 2021

Related U.S. Application Data
(60) Provisional application No. 63/050,241, filed on Jul. 10, 2020.

(51) Int. Cl. G06Q 30/00; G06Q 10/10; G06F 21/31

(52) U.S. Cl. CPC G06Q 30/018; G06F 21/31; G06Q 10/10

(57) ABSTRACT

Methods and systems are presented herein for managing data exchange with one or more vendors and/or their products or services for financial institutions.

### CROSS-REFERENCE TO RELATED APPLICATIONS

This application claims priority to and the benefit of U.S. Provisional Patent Application Ser. No. 63/050,241, filed Jul. 10, 2020, entitled “SYSTEMS AND METHODS FOR VENDOR EXCHANGE MANAGEMENT,” the disclosure of which is incorporated herein by reference in its entirety.

### FIELD OF THE INVENTION

This invention relates generally to systems and methods for managing client/vendor relationships. More particularly, in certain embodiments, the invention relates to systems and methods for providing vendor and agreement management.

### BACKGROUND

Financial institutions such as banks and credit unions are increasingly relying on third-party vendors to perform various important functions. While this improves efficiency and reduces cost for the financial institution, there are various risks posed by such outsourcing. A financial institution (“FI”) must establish a vendor oversight program to mitigate such risks, comply with various regulations, and pass examination by auditors. Generally, maintaining oversight of different vendors and vendor products requires a coordination of large amounts of oversight requirements, tasks, documents, results, due dates, and individuals.

The vendor management process has historically been disjointed, messy, and time-consuming. A single financial institution may have numerous vendors to manage, and there may be many individuals within a given financial institution who deal with a given vendor and must coordinate collection of documents and data regarding the corresponding vendor products. Furthermore, the terms of various contracts between a financial institution and its vendors must be carefully monitored.

Moreover, financial institutions may wish to maintain different types of information about the vendors and vendor products with which they are associated. Traditional vendor management systems allow financial institutions to maintain information according to a predetermined set of fields.

There is a need for a consolidated, efficient system for managing contracts between a financial institution and its vendors.

### SUMMARY

Methods and systems are presented herein for vendor exchange management system to provide one or more vendors of a financial institution to manage, for example, assessment generation and distribution.

In one aspect, the invention is directed to a method for managing one or more vendors and/or products. The method includes causing to display, by a processor of an enterprise system, one or more graphical user interfaces (GUIs) associated with one or more exchange modules. The method includes receiving, by the processor of the enterprise system, a first input (e.g., received via a graphical user interface widget) from a first client user (e.g., said first client user having been authorized to access the enterprise system, e.g., said first vendor client user being one member of a network of subscribed clients), the first input comprising instructions to access a create new account GUI. The method includes receiving, by the processor of the enterprise system, (e.g., received via a graphical user interface widget) data field information related to a first vendor. The method includes updating, in a memory of the enterprise system, vendor and/or product information stored in association with the first vendor, based on the subsequent input. The exchange module is configured to provide control assessments, manage vendor relationships, and share control assessments with the first vendor's customer base.

A subsequent input may include data field information relating to contact details and job descriptions of the first vendor. A subsequent input may include custom data field information related to a request to perform an assessment. A subsequent input may include instructions to create an email document to be sent to one or more clients of the first vendor. A subsequent input may include instructions to download an assessment.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a block diagram of an example system for managing contracts between a financial institution and its vendors.

FIG. 2 is a block diagram of the example system for managing contracts between the financial institution and its vendors in accordance with an embodiment of the invention.

FIG. 3 is an example main dashboard in accordance with an embodiment of the invention.

FIG. 4 is an example vendor dashboard in accordance with an embodiment of the invention.

FIG. 5 is an example document storage page in accordance with an embodiment of the invention.

FIG. 6 is an example workflow of the system in guiding an end-user in preparing a vendor oversight report associated with one or more selected vendor products in accordance with an embodiment of the invention.

FIG. 7 is an example vendor exam preparation workspace in accordance with an embodiment of the invention.

FIG. 8 is an example workspace for collecting documents by matching collected end-user's document to a list of suggested documents in accordance with an embodiment of the invention.

FIG. 9 is an example workspace for collecting documents by prompting the end user for selection of actions for unassigned documents that have been provided by the end user in accordance with an embodiment of the invention.

FIG. 10 is an example workspace for collecting documents by prompting the end user for selection of actions for unassigned suggested documents in accordance with an embodiment of the invention.

FIG. 11 is an example workspace for preparing a collected document for the examination report in accordance with an embodiment of the invention.

FIG. 12 is an example workspace for uploading document to be attached and included in the examination in accordance with an embodiment of the invention.

FIG. 13 is an example workspace to previewing contents to be included in the examination report.

FIG. 14 is an example workspace to review vendor products in accordance with an embodiment of the invention.

FIG. 15 is an example display for viewing product review in accordance with an embodiment of the invention.

FIG. 16 is an example alert and information display in accordance with an embodiment of the invention.

FIG. 17 is an example vendor name/email GUI in accordance with an embodiment of the invention.

FIG. 18 is an example contacts GUI in accordance with an embodiment of the invention.

FIG. 19 is an example contact list window/GUI in accordance with an embodiment of the invention.

FIG. 20 is an example add new contact GUI in accordance with an embodiment of the invention.

FIG. 21 is an example add a vendor product GUI in accordance with an embodiment of the invention.

FIG. 22 is an example resend invite GUI in accordance with an embodiment of the invention.

FIG. 23 is an example create new account GUI in accordance with an embodiment of the invention.

FIG. 24A and FIG. 24B are an example job description GUI in accordance with an embodiment of the invention.

FIG. 25 is an example Welcome GIU in accordance with an embodiment of the invention.

FIG. 26 is an example menu panel GUI in accordance with an embodiment of the invention.

FIG. 27 is an example menu panel (Control Assessments) GUI in accordance with an embodiment of the invention.

FIG. 28 is an example assessments GUI in accordance with an embodiment of the invention.

FIG. 29 is an example vendor level assessments GUI in accordance with an embodiment of the invention.

FIG. 30 is an example assessment overview GUI in accordance with an embodiment of the invention.

FIG. 31 shows an example assessment in accordance with an embodiment of the invention.

FIG. 32 is an example share your scores widget/GUI in accordance with an embodiment of the invention.

FIG. 33 is an example overall score-improve score widget/GUI in accordance with an embodiment of the invention.

FIG. 34 is an example improve score-contact information GUI in accordance with an embodiment of the invention.

FIG. 35 is an example improve score-contact information GUI-Mute Assessment in accordance with an embodiment of the invention.

FIG. 36 is an example Email GUI in accordance with an embodiment of the invention.

FIG. 37 is an example benefits of sharing window in accordance with an embodiment of the invention.

FIG. 38 is an example vendor level assessments GUI in accordance with an embodiment of the invention.

FIG. 39 is an example welcome GUI in accordance with an embodiment of the invention.

FIG. 40 is an example vendor selection GUI in accordance with an embodiment of the invention.

FIG. 41 is an example drop down menu GUI in accordance with an embodiment of the invention.

FIG. 42 is an example order GUI in accordance with an embodiment of the invention.

FIG. 43 is an example order/add to cart GUI in accordance with an embodiment of the invention.

FIG. 44 is an example shopping cart widget in accordance with an embodiment of the invention.

FIG. 45 is an example proceed to checkout widget in accordance with an embodiment of the invention.

FIG. 46 is an example order GUI with order pending in accordance with an embodiment of the invention.

FIG. 47 is an example order GUI with download in order history in accordance with an embodiment of the invention.

FIG. 48 is an example checkout GUI in accordance with an embodiment of the invention.

FIG. 49 is an example checkout GUI with empty cart in accordance with an embodiment of the invention.

FIG. 50 is an example Order History GUI in accordance with an embodiment of the invention.

FIG. 51 is an example status widget in accordance with an embodiment of the invention.

FIG. 52 is an example Requires Attention widget in accordance with an embodiment of the invention.

FIG. 53 is an example Cancelled item widget in accordance with an embodiment of the invention.

FIG. 54 is an example Exchange welcome GUI in accordance with an embodiment of the invention.

FIG. 55 is an example Exchange access widget in accordance with an embodiment of the invention.

FIG. 56 is an example White List Queue GUI in accordance with an embodiment of the invention.

FIG. 57 is an example White List Queue GUI displaying more than 10 results in accordance with an embodiment of the invention.

FIG. 58 is an example Status widget in accordance with an embodiment of the invention.

FIG. 59 is an example item list GUI with status selection widget in accordance with an embodiment of the invention.

FIG. 60 is an example Exchange widget in accordance with an embodiment of the invention.

FIG. 61 is an example Review Queue: Duplicate Control GUI in accordance with an embodiment of the invention.

FIG. 62 is an example Review Queue: Publish control and preview link widget in accordance with an embodiment of the invention.

FIG. 63 is an example ELA Queue: Duplicate and Publish Controls GUI in accordance with an embodiment of the invention.

FIG. 64 is an example Order Verification Queue: Client Indicator in accordance with an embodiment of the invention.

FIG. 65 is an example Verify Order: Exchange Order Information GUI in accordance with an embodiment of the invention.

FIG. 66 is an example Verify Order: Purchase Plan Warning widget in accordance with an embodiment of the invention.

FIG. 67 is an example Verify Order: Documentation Utilized widget in accordance with an embodiment of the invention.

FIG. 68 is an example Verify Order: Complete Order widget in accordance with an embodiment of the invention.

FIG. 69 is an example Verify Order: Order Cancellation widget in accordance with an embodiment of the invention.

FIG. 70 is an example ELA Queue: Client type filter GUI/widget in accordance with an embodiment of the invention.

FIG. 71 is an example ELA Queue: Modify Exchange Order GUI in accordance with an embodiment of the invention.

FIG. 72 is an example Modify ELA Order: Statuses for Exchange Orders GUI in accordance with an embodiment of the invention.

FIG. 73 is an example DC Users: Module Access GUI in accordance with an embodiment of the invention.

FIG. 74 is an example Fulfillment Vendor Match Queue widget in accordance with an embodiment of the invention.

FIG. 75 is an example Fulfillment vendor product search results widget in accordance with an embodiment of the invention.

FIG. 76 is an example Remove from queue widget in accordance with an embodiment of the invention.

FIG. 77 is an example Fulfillment Vendor Match Queue widget in accordance with an embodiment of the invention.

FIG. 78 is an example Finalize match to fulfillment vendor modal-Confirm in accordance with an embodiment of the invention.

FIG. 79 is an example Menu Item: Exchange GUI/widget in accordance with an embodiment of the invention.

FIG. 80 is an example Review Order: Updated View GUI in accordance with an embodiment of the invention.

FIG. 81 is an example Email Template: Assessments still in your cart! GUI in accordance with an embodiment of the invention.

FIG. 82 is an example Assistance Requested Email Template in accordance with an embodiment of the invention.

FIG. 83 is an example Control Assessments Quick Delivery Library Widget in accordance with an embodiment of the invention.

FIG. 84 is an example Add to Cart widget in accordance with an embodiment of the invention.

FIG. 85 is an example User does not have the ability to manage services widget in accordance with an embodiment of the invention.

FIG. 86 is an example Contact Provider widget in accordance with an embodiment of the invention.

FIG. 87 is an example Search Vendor Results widget in accordance with an embodiment of the invention.

FIG. 88 is an example Cart Icon-Review Order Modal widget in accordance with an embodiment of the invention.

FIG. 89 is an example Quick Delivery Library widget in accordance with an embodiment of the invention.

FIG. 90 is an example Control Assessments Modal widget in accordance with an embodiment of the invention.

FIG. 91 is an example Place an Order Page-Control Assessments widget in accordance with an embodiment of the invention.

FIG. 92 is an example Place an Order-Capability to Order All Services widget in accordance with an embodiment of the invention.

FIG. 93 is a block diagram of an example network environment for use in the methods and systems for analysis of spectrometry data, according to an illustrative embodiment.

FIG. 94 is a block diagram of an example computing device and an example mobile computing device, for use in illustrative embodiments of the invention.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Methods and systems are presented herein for assessing risk associated with a vendor providing services and/or other products to a financial institution, for preparation of associated risk assessment reports or vendor oversight reports, and for maintenance of a plurality of risk assessment reports associated with a plurality of vendors.

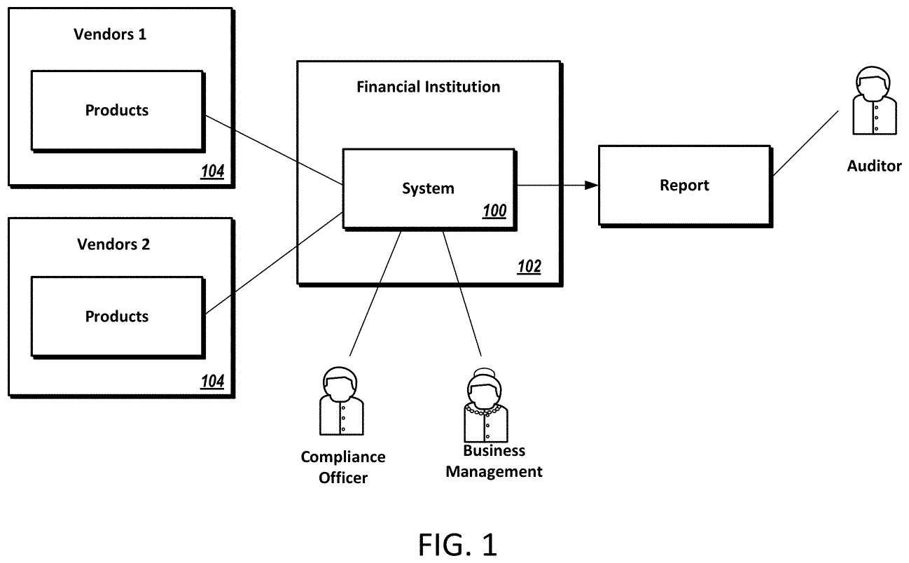

FIG. 1 is a block diagram of an example system 100 to assist financial institutions 102 to manage vendors 104 in accordance with an embodiment of the invention. In some implementations, the system 100 provides guided workflow to i) manage contracts with a given vendor 104, to provide a guided workflow to assist the financial institution 102 to prepare for an compliance or contract audit examination, ii) provide a rating system of the vendors 104 and their products and services, iii) provide a risk-assessment rating-system for the vendors 104, and iv) provide mechanisms for collaboration, the tracking of communication, and document storage.

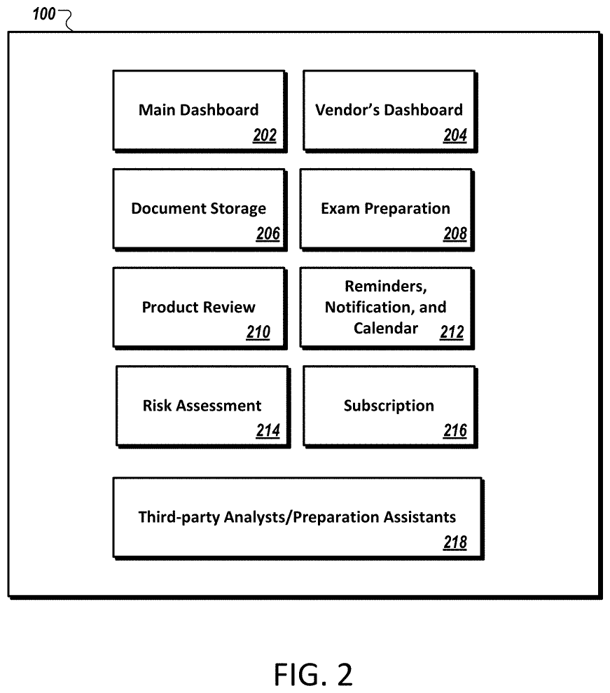

FIG. 2 is a block diagram of the example system 100 for managing contracts between the financial institution and its vendors in accordance with an embodiment of the invention. The system 100 may include a main dashboard 202 for managing actions associated with a given vendor 104 and to track such actions. The system 100 may include a vendor dashboard 204 to view and manage products and vendors associated with a given financial institution. The system 100 may include a document storage page 206 to view and manage documents associated with the vendors and their products. In some implementations, the document storage page 206 may be accessible via the main dashboard 202 and the vendor dashboard 204.

The system 100 may include a reminder, notification, and/or calendar function 212. The function 212 may manage and store a list of dates associated with expiration of a given document or contract as well as a list of personal reminders provided by the end-users. The function 212 may display such reminders in a calendar display. The function 212 may send notifications to the end-user based on pre-defined rules associated with an examination. The rules may be related to the expiration date of a given product or agreement, a scheduled examination, a risk-assessment evaluation, and etc.

The function 212 may include an alert and/or information feed (e.g., new documents uploaded, new reviews added, status update on a given examination or preparation process, etc.). The alert may include a progress bar to indicate a given end-user progress with a given task.

The alert may include an experience bar to indicate a given end-user usage level associated with the various functions of the system 100.

The system 100 may include a risk-assessment module 214 to guide an end-user in assigning a risk rating for a given vendor and/or product. The risk-rating may be utilized as part of the reporting of the compliance and/or contract audit examination. In some implementations, the risk rating may be used to determine the types of information and the types of documents to include in the examination report.

The system 100 may include a subscription module 216. The subscription module 216 may manage and maintain usage by the end-user of the various system components (e.g., 202, 204, 206, 208, 210, 212, and 214) for a given financial institution. The system 100 may monitor the end-user's action, such as the usage of complimentary tools and document storage, purchases of additional tools and document storage, purchases of enterprise features, among others.

In some example embodiments, the system may include one or more modules for executing, providing and/or causing to display one or more graphical user interfaces (GUIs) and/or widgets. The GUIs and/or widgets may include a vendor profile widgets for, among other things, managing vendor profiles; oversight grid widgets for, among other things, providing grid-based oversight of oversight requirements; task widgets for, among other things, managing tasks associated with oversight requirements; oversight management widgets for, among other things, managing tasks and oversight requirements associated with vendors and/or vendor products; document widgets for, among other things, managing documents associated with tasks;

administrator widgets for, among other things, managing users; dashboard widgets for, among other things, managing outstanding tasks and vendor products associated with users; and reports widgets for, among other things, generating status, task and/or vendor reports.

In some example embodiments, data associated with vendors (e.g., vendor management information), which is used by the GUIs and/or widgets, may be stored in a memory of the system 100 or of a client computing device associated with the system 100. In some example embodiments, the system 100 is an enterprise system with which one or more enterprise client computing devices are connected. The GUIs and/or widgets are described in further detail below.

Main Dashboard

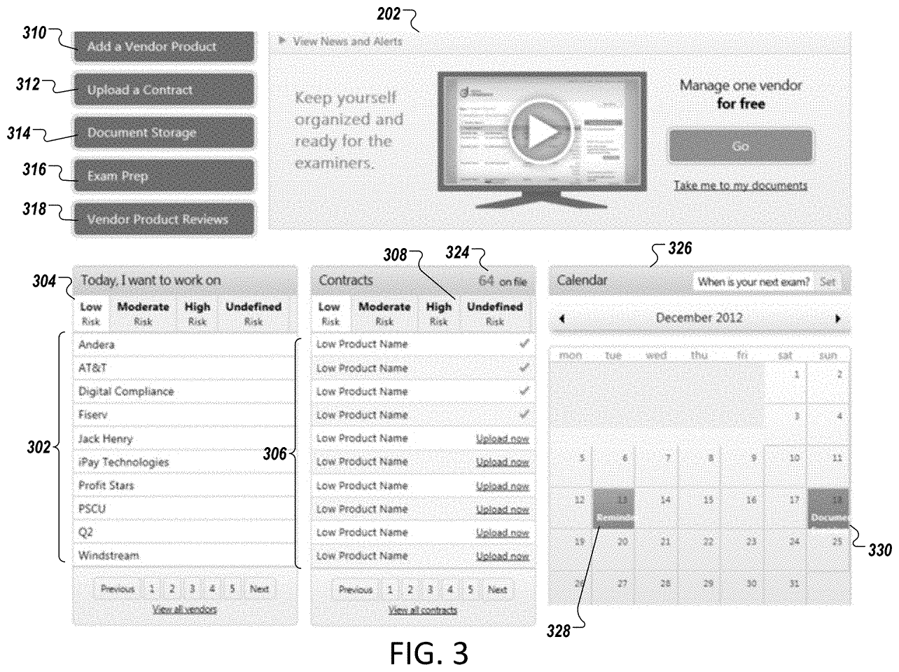

FIG. 3 is an example main dashboard 202 in accordance with an embodiment of the invention. The main dashboard 202 may be used to initiate the various functions, as described in relation to FIG. 2. The main dashboard 202 may display a vendor list 302, which may be organized and filtered by a vendor's risk level 304 (e.g., low, medium, high, or undefined/unknown). The main dashboard 202 may display a contract list 306, which may also be organized and filtered by risk levels 308. The main dashboard 202 may display a number of contracts on file (324), such as those stored in the document storage 206.

The main dashboard 202 may include a calendar 326 that displays reminder dates 328 and expiration dates 330 of contracts, of risk assessment of vendors and/or products, as well as of upcoming examinations. In some implementations, the calendar 326 may include dates in which notifications will be sent by the system. In some implementations, the calendar 326 may only display the expiration dates for documents that are uploaded by the end-user.

In some implementations, upon selecting a date in the calendar 326, the system 100 may prompt the end-user to create a reminder (e.g., for email communication, SMS-message, and other methods of notification accessible to and specified by the end-user). The system 100 may display a content of a reminder when the end-user hovers the cursor thereover. The calendar may be a part of the reminders, notification, and calendar function 212. The alerts and reminders of the calendar 326 may be employed to notify the end-user of upcoming critical dates (e.g., renewal date). The notification may be generated based on the date of the given activity having met an alert condition (e.g., exceeding a date threshold in relation to the critical date).

The main dashboard 202 may include a function to add a vendor product (310), a function to upload a contract associated with a given product (312), a function to manage stored documents (314), a function to prepare for an examination (316), and a function to review and manage reviews for a given vendor products (318).

The main dashboard 202 may be displayed to the users upon login to the system 100.

In some implementations, when adding a new vendor product (310), the system 100 may present the end user with a list of products. The list may include all products associated to the financial institution, including those that are not currently being managed by any of the end-user of that institution as well as those that do not have a contract loaded. The list of products may be maintained within a database that is managed by the system 100.

When adding a new vendor product, the system 100 may present the end-user with a list of questions associated with the product. The questions may include a request for the vendor name, the product name, the product type, and a risk level. The risk level may be defined as low, medium, high, and undefined (as corresponding to the risk level 304). Alternatively, the risk level may be an input from the risk-assessment module 214.

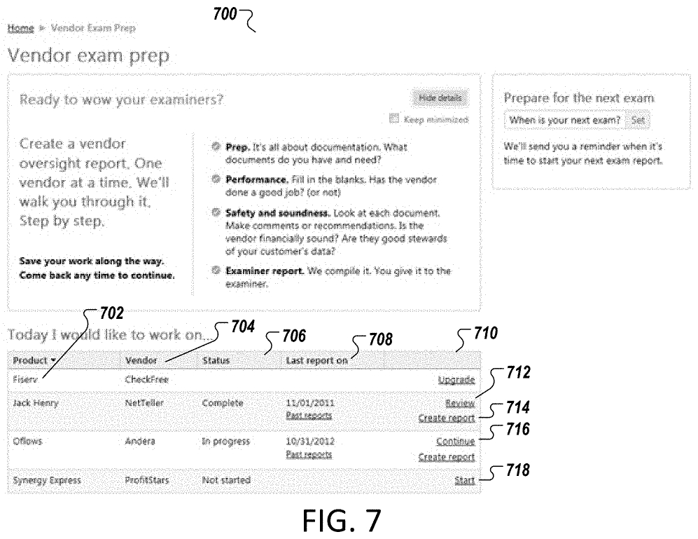

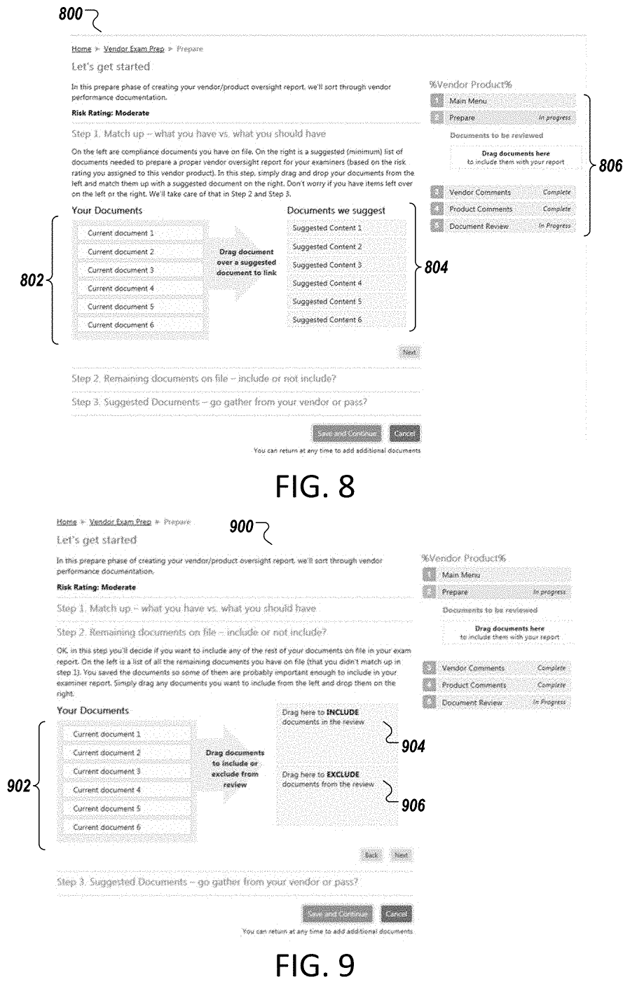

In some implementations, the risk-levels 304, 308 may be used to determine a suggested document 320 (see—see FIG. 8) in the examination-preparation area 322 (not shown—see FIGS. 7-13). Once the vendor product is added, the system 100 may present the end-user with a notification that the product has been added. In the notification, the system 100 may include a link or a selection that allows the end-user to upload a contract associated with the added vendor product. The system may also provide a link or selection to add a collaborator or to add contact information of the vendor.

In some implementations, the system 100 allows more than one person to interact with a vendor. The collaboration function allows the system 100 to receive information from the end-user about co-workers or other people in the end-user's organization that may perform actions or provide reviews for a given vendor and/or vendor product. In some implementations, the collaborator may perform any of the end-user's function (e.g., upload contract, add notes and reminders, save email conversation, and document events), though may not change or undo any of the actions performed by the end-users. Each of the vendor products may be assigned a different point of contact (i.e., a product manager). The system 100 may provide a search function for the end-user to determine if an added collaborator is already registered with the system 100.

In some implementations, when uploading a contract associated with a given product (312), the system 100 may prompt the end-user for a file. Multiple files may be selected and uploaded in a given instance. The system 100 may send a notification to the end-user that the contract has been uploaded and that a notification will be sent when it is ready for review. In some implementations, the contract may be transmitted to a third-party that analyzes and/or prepare the contract for review by the end-user. The system 100 may use aliases table. Examples of tools utilized by the third-party to analyze and prepare the contract are described in Appendices E and F of the U.S. Provisional Patent Application No. 61/805,066, which is incorporated by reference herein in its entirety.

Vendor Dashboard

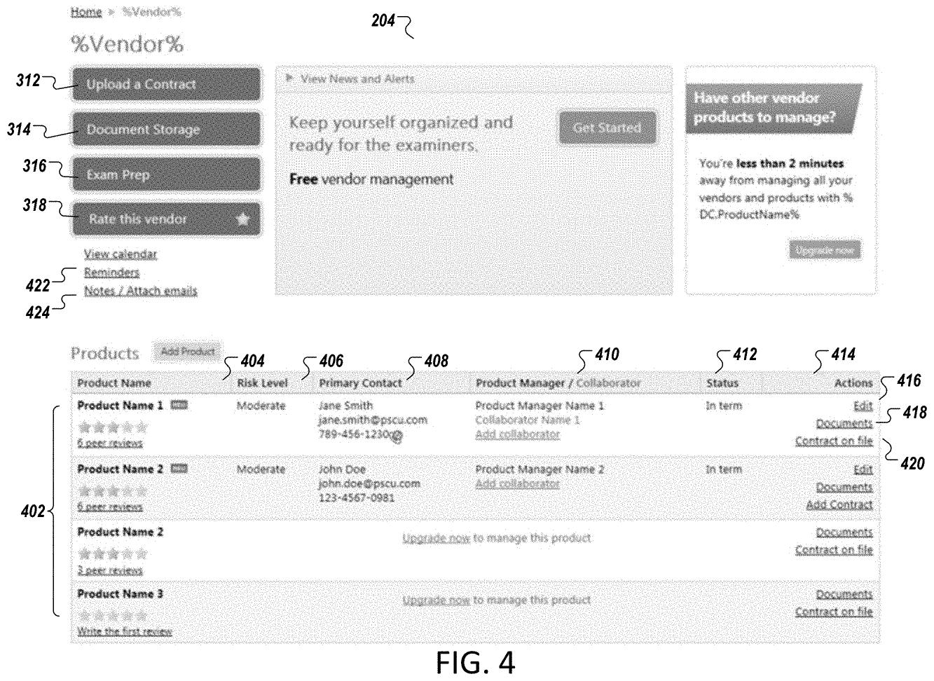

FIG. 4 is an example vendor dashboard 204 in accordance with an embodiment of the invention. In some implementations, the vendor dashboard 204 may be accessed by the end-user when the user selects a vendor from the list of vendors 302 in the main dashboard 202.

In some implementations, the vendor dashboard 204 may include the function to upload a contract associated with a given product (312), the function to manage stored documents (314), the function to prepare for an examination (316), and the function to view and manage reviews for a given vendor products (318).

In some implementations, the vendor dashboard 204 may include a list of vendor products (402) that are associated to the financial institution. The list 402 may include, for example, but not limited to, products that are currently being managed as well as products that are yet to be assigned to a given product manager. For each of the products in the list 402, the system 100 may display a product name 404, a risk level that has been assigned to the product 406, a vendor contact information 408, an assigned product manager (of the financial institution) 410, a status indicator of the product 412, and actionable tasks 414 associated with a given product. The actionable tasks 414 may allow an end-user to edit a given product information (416), to view or manage the document associated with the given product (418), and to add a contract or edit the contract on file associated with the given product (420).

Upon a selection of a product in the list 402, the system 100 may prompt the end-user whether to assign a product-manager for the product. The prompt may further include details and information about the product, including, for example, the vendor name, the product name, the product type, and the source of the product. Upon the end user providing the information, the system 100 may provide options to allow the end-user to upload a contract, to add a collaborator, or to add contact information.

Upon a selection to edit a product (416), the system 100 may display the information about an added product (e.g., the vendor name, the product name, the product type, and a risk level), as described in FIG. 3. The system 100 may also display the vendor's contact-information and/or a list of assigned collaborators.

The system 100 may provide a selection to allow the end-user to remove collaborators from specific products.

Upon a selection to edit a contract (420) associated with a product, the system 100 may display information relating to the contract, including the status of the contract (e.g., “in-term”, “renewal negotiation”, “auto-renew”, “cancelled”, “replaced”, etc.), the contract files (which may include one or more files), the end-user that uploaded the contract, the upload date, the contract date, the contract expiration date, a list of products associated with the contract, and certain key clauses (e.g., whether the contract includes an auto-renewal clause, information relating to the number of days required for a non-renewal notice, and an auto-renewal period). The system 100 may also display information relating to the contract terms (e.g., sale price per unit, etc.), comments associated with the term (e.g., whether the contract is a service-level agreement (SLA)), the vendor signatory, the institution signatory, among others. The system 100 may provide a prompt to the end-user to edit or replace the contract.

In addition, the system 100 may take actions and set reminders. Example actions of the system 100 are summarized in Table 1.

TABLE 1

| Status | Description | Action | Email Communication |
|---|---|---|---|
| In Term | Contract has not reach | No action taken | Initiate communication |
| | expiration date | | six months from |
| | | | expiration date |
| Renewal | Financial Institution is | No action taken | Sent on the expiration |
| negotiation | working on a new contract | | date |
| | terms | | |
| Auto- | Automatically renew terms | Change the contract | Sent on the expiration |
| Renew | of the contract based on the | expiration date based | date |
| | info entered when the | on the terms loaded in | |
| | contract was loaded | the upload contract | |
| | | form | |
| Cancelled | Contract is no longer valid | All products/documents | Sent on the expiration |
| | | associated with the | date |
| | | contract will | |
| | | also be in cancelled | |
| | | status and archived | |
| Replace | Financial Institution | Move old contract to | |
| | replacing the existing | archives/new | |
| | contract with a new one | contract starts the | |
| | | upload contract | |
| | | process over | |

In addition, upon a selection to edit a contract, the system 100 may provide guidance to the end-user depending on the various selected options. For example, if the end-user specifies “renewal negotiation” (which indicates that the end-user is currently negotiating the contract with the vendor), the system 100 may provide a message that states: “By setting a contract to renewal-negotiation, you will no longer receive notices regarding contract expiration and/or auto-renewal. Change your status when you are ready. You can either upload your new contract or cancel your existing contract.” The system 100 may also take action, such as to stop the sending of the contract expiration emails.

In another example, if the end-user specifies “auto-renew” (which indicates that the contract would auto-renew with the terms as originally provided), the system 100 may prompt the end-user for a new expiration date for the contract and a date for new reminders.

In yet another example, if the end-user specifies “cancelled” (which indicates that the contract has been canceled), the system 100 may notify the end-user that the system 100 will cancel all of the selected products, archive all of the uploaded documents, and archive all of the uploaded contracts. The system 100 may also prompt the end-user for new vendor information. The system 100 may also prompt the end-user to upload a new contract or document.

In yet another example, if the end-user specifies “replace contract” (which indicates that the end-user wishes to replace an existing contract with a new contract), the system 100 may prompt the end-user for new documents associated with the new contact. The system 100 may archive the old contract in an archived folder. The old contract may be accessible to the end-user at the document storage page 206. In some implementations, the system 100 may also sent the new document to the third-party 218 for analysis and preparation.

Still looking at FIG. 4, the vendor dashboard 204 may include features to assist the end-user in managing reminders and notes associated with the vendor product. For example, the vendor dashboard 204 may include an option to display all of the reminders (422) associated with a given vendor.

The vendor dashboard 204 may include an option to attach and view notes and correspondences (424) (e.g. electronic mail) associated with the vendor. In some implementations, the system 100 may present the information as a list that includes the dates that the note was created, a title for the note, a note type, a product name, an identifier of the end-user that created the note, a vendor name, a product name, and a note message. The list may be filed, sorted, or organized using the note title, the email information, or by the product information.

Document Storage

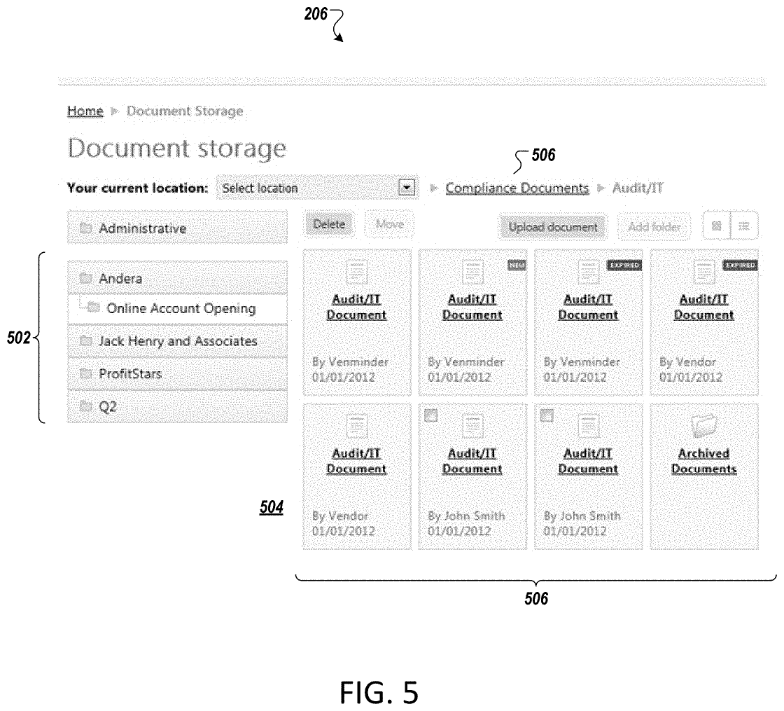

FIG. 5 is an example document storage page 206 in accordance with an embodiment of the invention. The document storage page 206 allows an end-user or product manager to view and manage documents associated with a given vendor.

In some implementations, the document storage page 206 may display a list of product managers 502 and the documents they are managing or collecting. The document storage page 206 may include a workspace 504 for managing and viewing a set of collected documents. The workspace 504 may allow the end-user to organize the set of documents in a set of vendor folders. The vendor folders may include documents and folders associated to a given vendor and vendor product.

In some implementations, the document storage page 206 may include a compliance document folder 506 to be used for the examination preparation effort. The compliance document folder 506 may include folders relating, for example, to “audit/IT”, “business continuity”, “financial”, “insurance”, “miscellaneous”, “policy”, and “product management.”

Upon a selection to upload a new document, the document storage page 206 may prompt the end-user for a file to upload, a document description, a document date, comments, and/or reminders.

The document storage page 206 may restrict the transfer of files. In some implementations, once a document has been uploaded, for example, to the compliance document folder 506, the document storage page 206 may prohibit the end-user from moving these documents to a different folder. To this end, the system 100 may require the end-user to delete the file and re-upload the file to the different folder. In some implementations, the document storage page 206 prohibits the addition of new folders to the compliance document folder 506.

As another example, only documents uploaded by the end-user may be moved by the end-user. The document storage page 206 may indicate to the end-user the documents that they have permission to move. The document storage page 206 may indicate the owner of the document.

The document storage page 206 may label the various uploaded documents. For example, in some implementations, the document storage page 206 may label documents that have been newly uploaded by the third-party 218 or by the vendor as “new”. The label may appear only during a first login session by the end-user, and the label may be removed in subsequent sessions. Other labels may include “expired.”

Exam Preparation

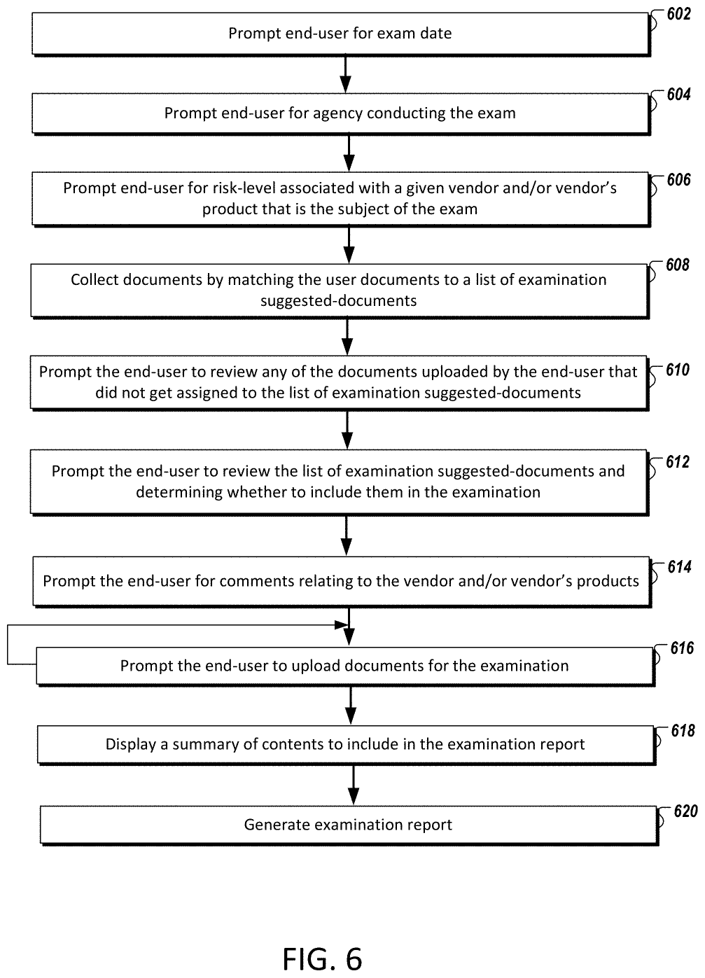

FIG. 6 is an example workflow of the system 100 to guide an end-user to prepare a vendor oversight report associated with one or more selected vendor products in accordance with an embodiment of the invention. The workflow may be referred to as “Exam Prep”. The Exam Prep may be used to assist and guide the users of a financial institutions to prepare, for example, for its annual exam with a given government agency, regulatory body, or auditing process. In some implementations, the Exam Prep may collect all of the documents that will be the subject of the examination. The Exam Prep may collect all of the notes and correspondences associated with a product. The Exam Prep may allow the end-user to review all of these documents. The Exam Prep may allow end-users to invite experts and/or collaborators to assist with the exam preparation. The Exam Prep may create or generate a report for the examiners.

In some implementations, the Exam Prep workflow may be initiated from the main dashboard 202 or the vendor dashboard 204, as described in relation to FIGS. 3 and 4.

Upon initiation of the Exam Prep workflow, the system 100 may prompt the end-user for examination information, including, for example, a date of the next regulatory exam (step 602). The system 100 may use the provided date to track the number of days remaining until the examination and to determine when notification (e.g., by email) regarding the examination may be sent. In some implementations, the system 100 may send, for example, a reminder to an end-user that created the report (and/or the product manager) 90 days before the examination. The reminder may indicate to the end-user that the report is ready for the end-user's review. The system 100 may also send a reminder, when no report has been generated, to an end-user to remind them to start a report.

In the Exam Prep workflow, in some implementations, the system 100 may prompt the user for a list of one or more agencies to be included in the examination (step 604). Examples of the agencies may include, for example, but not limited to, the Consumer Financial Protection Bureau (CFPB), Federal Deposit Insurance Corporation (FDIC), Federal Reserve System (FED), National Credit Union Administration (NCUA), and/or the Office of the Comptroller of the Currency (OCC).

In some implementations, the system 100 may also prompt the end-user for a risk-level (e.g., low, medium, high, and undefined/unknown) associated with the vendor and/or vendor product, if the information has not been provided, for which the examination is being prepared (step 606). The risk-level may be an input from the risk-assessment module 214. The system 100 may use the provided risk-level to determine suggested documents for the examination-preparation process.

FIG. 7 is an example vendor examination-preparation workspace 700 in accordance with an embodiment of the invention. The workspace 700 may display a list of products 702. For each of the products 702, the workspace 700 may display the vendor name (704), the status of the examination (706), the last reported date (708), and actionable tasks 710.

The last reported date 708 may be, for example, the last time a report was created or the last time the product was examined. The status of the examination (706) may include “complete”, “in progress”, and “not started.” A list of the examination status is shown in Table 2.

TABLE 2

| Status | Description | Action |
|---|---|---|
| Complete | All steps have been | Review, Preview |
| | completed | report |
| In progress | Started but not all steps | Continue, Preview |
| | completed | report |
| Not started | No steps have been started | Start |

The actionable tasks 710 may include reviewing an examination report (712), creating a report (714), continuing a report (716), and starting a report (718).

The system 100 may save all of the work, including all of the actions taken by the end-user. To this end, the end-user can continue from another point in the examination preparation process.

Referring back to FIG. 6, in some implementations, the method 600 may include matching all of the end-user's uploaded documents to a list of examination suggested documents (step 608). The list of examination suggested documents may be a pre-defined list selected from a set of pre-defined list. The pre-defined list may be selected based on the risk-level associated with the given product or vendor subject to the examination.

FIG. 8 is an example workspace 800 for matching collected end-user's document to a list of suggested documents in accordance with an embodiment of the invention. The workspace 800 may display a list of collected documents uploaded by the end-user (802). The list may include documents collected in the compliance document folder, as described in relation to FIG. 5. The workspace 800 may display a list of suggested documents (804) for the examination. The list of suggested documents (804) may be a pre-defined list of documents that is organized by risk levels. The workspace 800 may allow the end-user to select a document from the collected list (802) and “drag and drop” it to a suggested content in the list of suggested documents (804). The action may merely associate the documents in that no files are moved.

The system 100 may display a status of the workflow (806). The status may include an indicia of the current process being performed by the end-user and a status of the other processes (e.g., complete, in-profess, or ready to start) in the workflow.

Referring back to FIG. 6, in some implementations, the method 600 may include prompting the end-user to review any of the collected documents uploaded by the end-user that was not assigned to the list of the examination suggested-documents (step 610). FIG. 9 is an example workspace 900 for prompting the end-user to review the unassigned documents 902 that has been collected to the document storage page 206, but has not been assigned in FIG. 8. In some implementations, the system 100 may prompt the end-user to identify each of the unassigned documents as either to include (904) or exclude (906) from the report/examination.

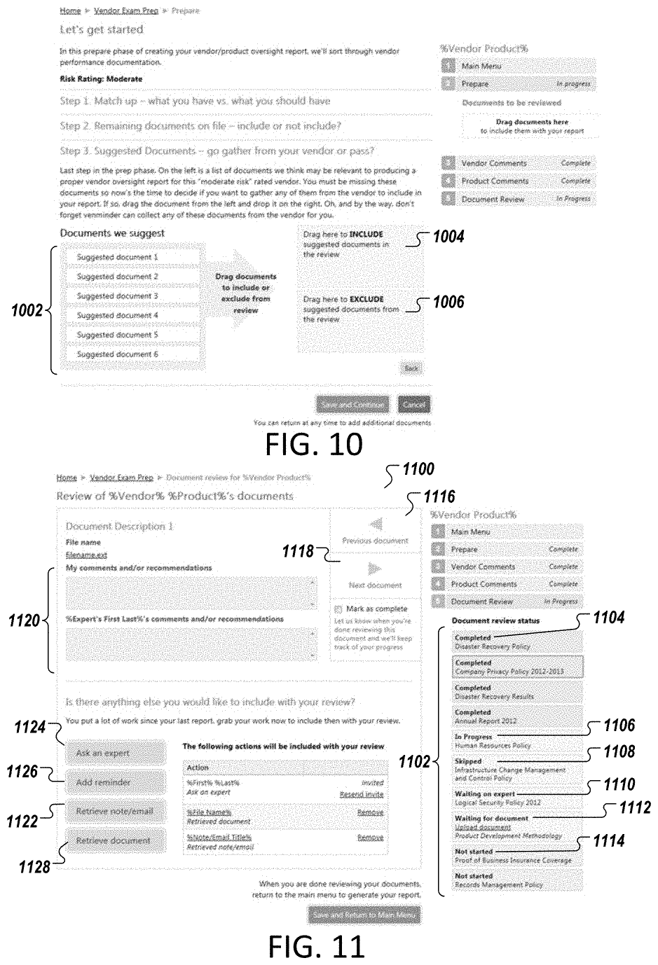

Still looking at FIG. 6, in some implementations, the method 600 may include prompting the end-user to review the list of examination suggested-documents and determining whether to include them in the examination (step 612). FIG. 10 is an example workspace 1000 for prompting the end-user to review the unassigned suggested documents 1002. The system 100 may prompt the end-user to identify each of the unassigned suggested documents as either to include (1004) or exclude (1006) from the report/examination.

Still looking at FIG. 6, in some implementations, the method 600 may include prompting the end-user to provide comments about the vendor (step 614). The comments may be in response to interrogatories, such as (i) “What has the vendor done well since your last exam date,” (ii) “What has not gone well since your exam date,” and (iii) “What actions are you going to take before your exam date.” The system 100 may also prompt the user to provide comments for each of the vendor product that is being examined.

Still looking at FIG. 6, in some implementations, the method 600 may include displaying (step 614) all of the documents that has been matched between the end-user's uploaded documents and the list of suggested documents (as described in relation to FIG. 8) as well as those documents that are marked to include (as described in relation to FIGS. 9 and 10). FIG. 11 is an example workspace 1100 for preparing the collected document for the examination report in accordance with an embodiment of the invention. The system 100 may display a status label for each of the documents. The status label may include “completed” 1104, “in progress” 1106, “skipped” 1108, “waiting for experts” 1110, “waiting for documents” 1112, and “not started” 1114. The status labels are described in further detail in table 3.

TABLE 3

| Document Status-Label | Description |
|---|---|
| Not Started | Included in exam but the user has not |
| | reviewed it |
| Waiting on expert | Expert has been invited but no response |
| | provided |
| Waiting for documents | Document type is included in exam but |
| | document has not been uploaded |
| Skipped | Viewed the document but preformed no actions |
| In Progress | Actions preformed but not marked as complete |
| Complete | Checked the box mark as complete |

In some implementations, the system 100 may provide a navigation function to allow the end-user to scroll through the various selected documents. The navigation function may include an arrow to review the previous selected document (1116) or the next selected document (1118). For each of the selected documents, the system 100 may allow the end-user to add comments (1120), to retrieve an electronic correspondence or note (1122), to invite an expert and/or collaborator to provide comments or to assist in the document preparation (1124), and/or to set reminders (1126).

Upon selection to invite a co-worker/expert (1124), the system 100 may provide a list of co-workers and/or suggested experts for the user to send a message. The system 100 may also prompt the end-user for a name, contact information, and a message to send to a co-worker and/or expert. The system 100 may accept multiple requests for comments.

The system 100 may allow each of the co-workers and/or experts to register and login. After which, the system 100 may only allow the co-worker and/or expert to view and provide comments for the vendors and/or vendor product to which they were asked for comments. The system 100 may send a notification to the end-user subsequent to a comment being provided. The system 100 may also send a notification when the co-worker and/or expert has registered to the system 100.

Upon receipt of comments from a given co-worker and/or expert, the system 100 may label the request as being complete. The system 100 may also update the Exam Prep workspace 1100 with the received solicited comments. To this end, the system 100 may provide an organized and efficient framework to request for comments from internal and external collaborators, to track such requests, and to review and utilize such comments in the examination-preparation process.

Upon selection of an input to retrieve an electronic correspondence or note (1122), the system 100 may display a list of notes and correspondences stored within the system 100. The system 100 may provide a date, a title, a correspondence type (e.g., email, notes, SMS, etc.), and an identity of the end-user and/or product manager that performed the uploaded. The system 100 may allow the end-user to filter the list based on the correspondence type.

Still looking at FIG. 11, the system 100 may allow the end-user to retrieve additional documents (1128) related to the vendor product. A selection of this input (1128) may direct the end-user to the document storage page 206, as described and shown in relation to FIG. 5. The end-user may add documents to the examination preparation process from there.

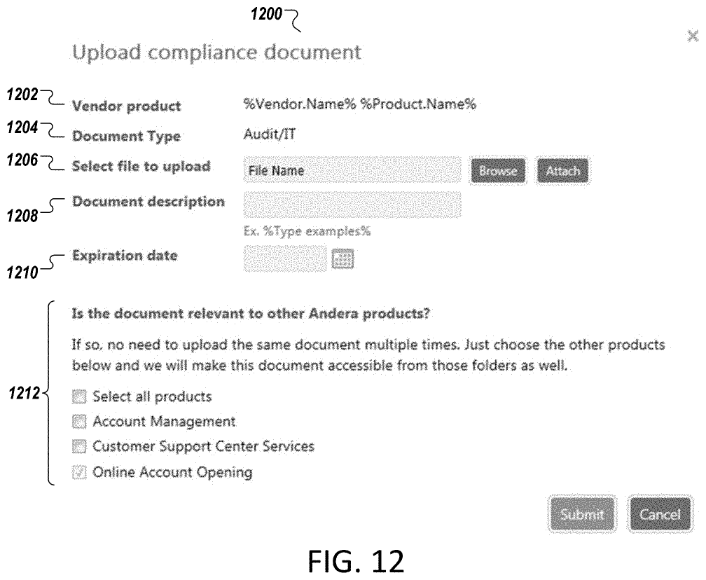

Referring back to FIG. 6, in some implementations, the method 600 may include prompting the end-user to upload documents for the examination (step 616). FIG. 12 is an example workspace 1200 for uploading document to be attached and included in the examination in accordance with an embodiment of the invention. The workspace 1200 may display the vendor product name 1202 and the document type 1204. The workspace 1200 may prompt the end-user for a file (1206), a document description (1208), an expiration date (1210), and a selection to use the document for other products (1212). The selection (1212) allows the end-user to have to upload a given document only once as the document can be applied to multiple products that may be the subject of one or more examinations. The workspace 1200 also allows the end-user to tailor comments and descriptions for each of the documents to be included in the report.

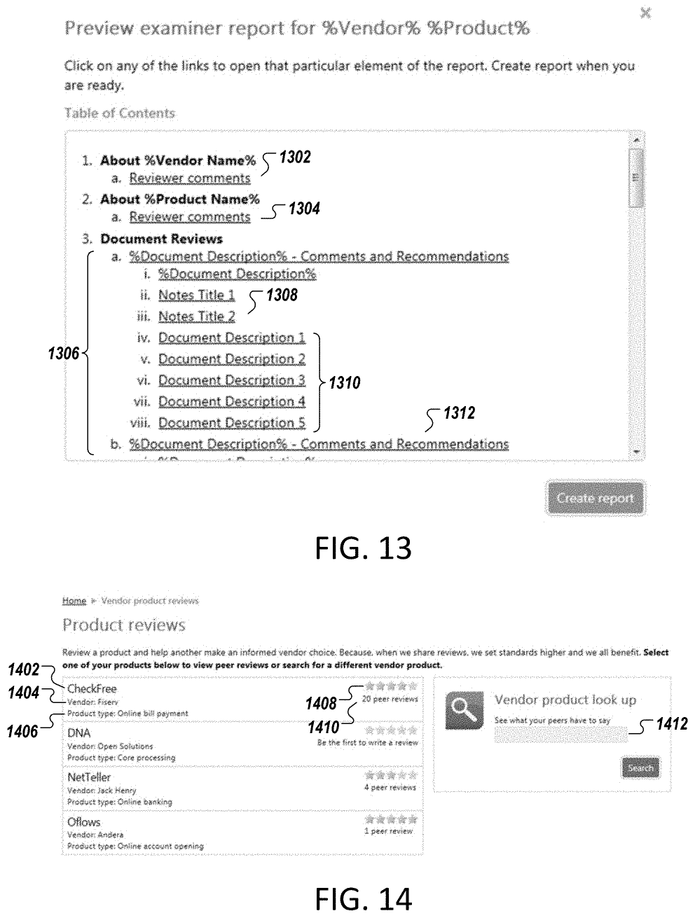

Still looking at FIG. 6, in some implementations, the method 600 may include displaying a summary of contents to include in the examination report (step 618). FIG. 13 is an example workspace 1300 to preview contents to be included in the examination report. The contents may include, for example, but not limited to, the reviewer's comments about the vendor (1302), the reviewer's comments about the products (1304), and the documents to include in the report (1306). The documents 1306 may include notes (1308), documents (1310), and comments and recommendations (1312). The system 100 may allow the end-user to preview any of the uploaded documents, comments, and notes as collected by the system 100.

Still looking at FIG. 6, in some implementations, the method 600 may include generating an examination report in accordance with an embodiment of the invention (step 620). The report may be generated, for example, as a PDF (“portable document format”) file. In some implementations, the report may be generated as a compressed file (e.g., a ZIP (archive file format) file). Upon a creation of the examination report, the system 100 may add the report to an archive section to which the end-user can later review the report. The system 100 may also update the vendor and product dashboard to indicate the recent addition of a new report as well as the status of the last instance that a report had been created. In some implementations, the system 100 may send a notification to the end-user to recommend initiating a new report (in the case of an annual report). The notification may be sent, for example, 9 months after the examination report has been generated.

Vendor Product Review

The system 100 may include a vendor product review workspace to allow the end-user to view and provide reviews/ratings for a given vendor, as described in relation to FIG. 3. In some implementations, the system 100 may display the performance rating and/or the listing of one or more performance comments received from users of the given vendor product and/or one or more corresponding products provided by one or more different vendors.

FIG. 14 is an example workspace 1400 to review vendor products in accordance with an embodiment of the invention. The workspace 1400 may display, at any given instance, a composite of multiple vendor products. The composite may include preferably four to five vendor products. Of course, any of number of vendor products may be displayed on the workspace 1400. For each of the products, the workspace 1400 may display the vendor name (1402), the product (1404), the product type (1406), a rating value 1408, and an indication of the number of reviews (1410). In some implementations, the system 100 may provide a search tool 1412. In some implementations, the system 100 may also provide a rating/review module for a given vendor.

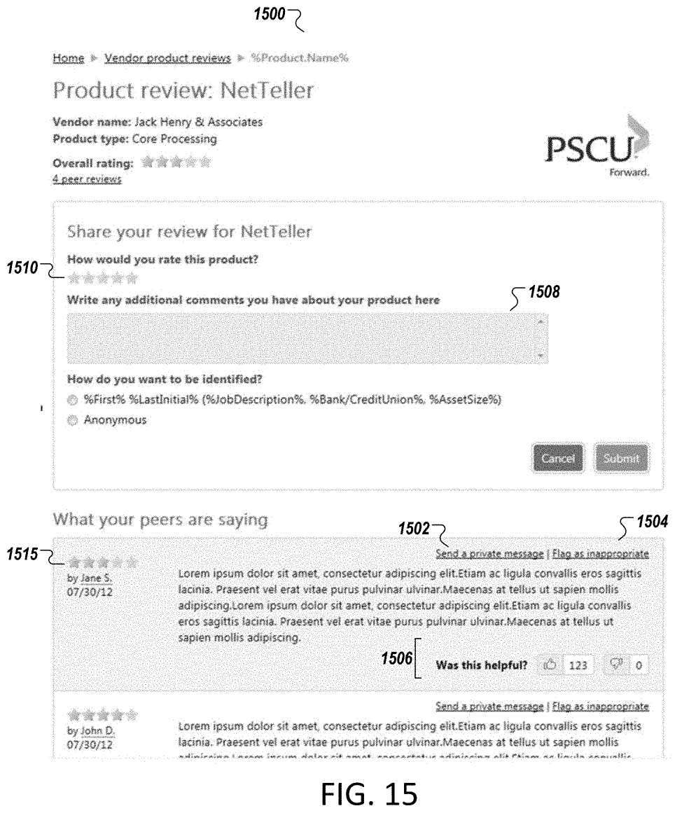

FIG. 15 is an example display 1500 for viewing product reviews in accordance with an embodiment of the invention. In some implementations, the system 100 may provide a prompt 1502 for the end-user to send a private message to the vendor or to the reviewer. The system 100 may also provide a prompt 1504 to flag the review as being inappropriate. The flag may generate a notification to a designated reviewer to determine whether the message is appropriate to display. The system 100 may also display an indicator of the number of people that flagged the review as being helpful and/or unhelpful.

The system 100 may prompt the end-user to provide a review 1508 for a given selected product. The end-user may provide a rating value 1510 (which may a star rating), comments, and identifier/contact information.

In some implementations, the display 1500 may include a listing of performance ratings (1512) received from various end-users and/or product managers of the various vendor products. The listing may be organized (e.g., ordered) on the graphical user interface according to popularity (e.g., number of “likes” received for each of the performance comments).

News and Alerts

The system 100 may include an alert and/or information feed that provides information about changes that have been made (e.g., new documents uploaded, new reviews added, and status updates for a given examination or preparation process, etc.). The alert may include a progress bar to indicate a given end-user progress with a given task.

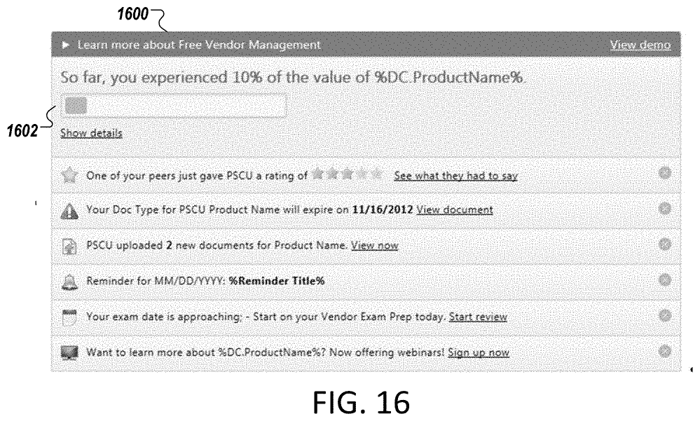

FIG. 16 is an example alert and information display 1600 in accordance with an embodiment of the invention. The display 1600 may include an experience bar 1602 that shows a given user's level of experience with the system 100. The system 100 may calculate the experience bar based on a set of tasks or functions performed by the end-user within the system 100. Each function may be assigned a function value, which may be aggregated to produce a total experience value. The experience bar 1602 may display the total experience value to the user. Examples of assigned values for a set of functions are provided in Table 4.

TABLE 4

| Function | Link | Percentage |
|---|---|---|
| Add Contract | Upload Contract | 10% |
| Add 2 Compliance Documents | Document Storage | 5% each |
| Add a vendor product | Add Vendor Product | 10% |
| Add a collaborator | Vendor Dashboard | 10% |
| Attach an email and Note | Emails and Notes | 5% each |
| Add a reminder | Reminders | 10% |
| Preform Exam Prep | Exam Prep | 20% |
| Write a review | Vendor Product Review | 10% |

Exchange Module

In another aspect of an embodiment, a client user of a system 100 may be presented with the capabilities to order Control Assessments, where a subject matter expert analyze vendor controls and assess the vendor's effectiveness in reducing risk. To perform these assessments, often the burden falls on the third-party vendor to supply documentation of vendor controls for an assessment in which the vendor receives no exposure.

The Exchange module of system 100 is a highly strategic initiative and set of tools to engage the vendor and include the vendor in a vendor management network. The first phase of this initiative is to invite the third-party vendor to a new area of the system application where a user of a vendor can achieve the following: view Control Assessments performed on their controls; contact (for example, via computer network) a Vendor Relationship Manager for opportunities to improve assessment ratings; and share control assessments with their customer base.

Contracted and non-contracted clients/client users may be provided with the capabilities to use a hyperlink shared by the vendor to preview and order the full assessment. Contracted clients may receive an updated widget on the Main Dashboard that provides control assessments readily available for purchase on their vendor products.

The system Admin portal may accommodate orders facilitates through the system's Exchange module.

In some embodiments, a system may include capabilities for Vendor Initiatives: the system may include user experiences for vendors and non-contracted clients to preview control assessments. Non-contracted clients/client users may be presented with the capabilities to order assessments. In some embodiments, a system may include capabilities for a One-to-Many Initiative: Main Dashboard Widget: Updates to system Admin and Client experiences that permit contracted clients to order control assessments published to system's Exchange module

In some implementations, for example, in a system upgrade or update, one or more areas that refer to an assessment as an analysis may be renamed. This will update in the following areas: the Executive Level Analysis (ELA) Queues, templates for in-app assessments, PDF documents, client support, system app, and SQL reports in DC Admin (e.g., one or more administrator users that are part of the system provider, e.g., employees of the system provider). For assessments that are done manually, it will may the responsibility of the client user completing that assessment to update their templates.

In some implementations, in order to manage the fulfillment vendor contacts, updates may have been made to indicate the contact type, their job description (selected during enrollment), whether a user wishes to receive notifications of their completed assessments and a list of approved domains.

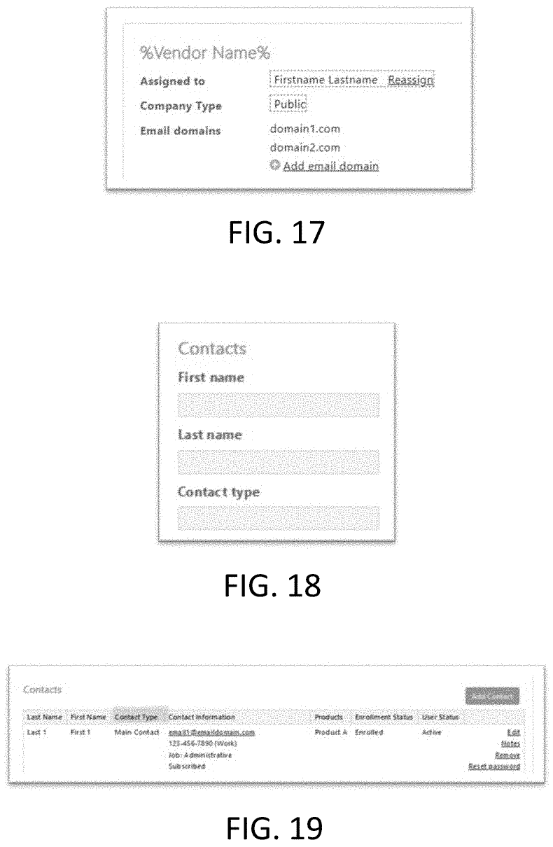

In some implementations, additional levels of security maybe applied to functionalities surrounding who can be added as a contact for a vendor. This will ensure when a user is added, their email address is considered approved for that vendor. An example vendor name/email GUI is shown in FIG. 17.

When adding a new fulfillment vendor contact or editing an existing one, the ability to indicate the contact type may be its own free form field. An example contacts GUI is shown in FIG. 18.

Contact type will have its own column on the list of vendor contacts. Upon release, any contacts that include the type as part of the name may be corrected to show in the contact type column. An example contact list window/GUI is shown in FIG. 19.

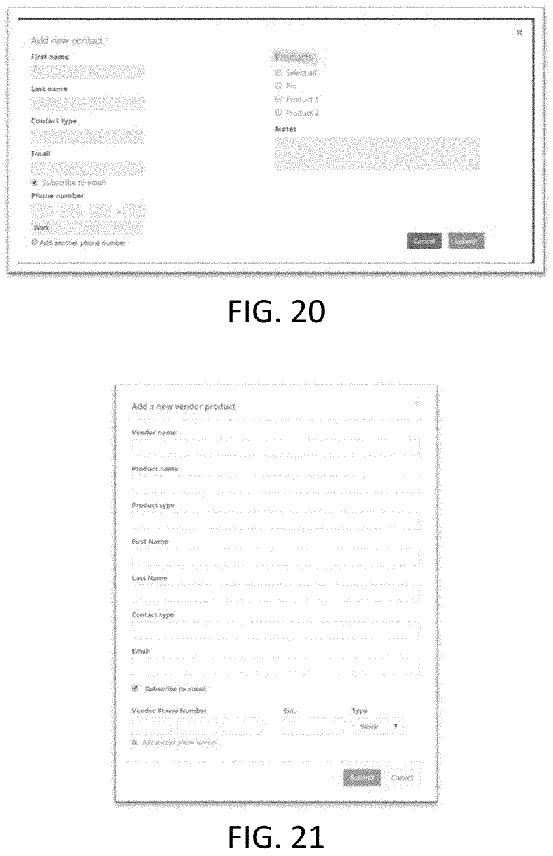

Assigning the product(s) to the vendor contact may indicate their association with the vendor. The product association with a contact is what determines whether a user (e.g., a client user or a vendor user) will receive a notice on completed assessment. In some embodiments, if a user (e.g., a client user or a vendor user) is only affiliated with 1 out of 5 products, they will not receive notifications on the other 4. An example add new contact GUI is shown in FIG. 20.

A fulfillment vendor can be added in other areas within DC Admin. In some embodiments, a user may be presented with the capability to add a contact at the same time. Other areas include, Service Verification queue, ELA Modify and document collection. An example add a vendor product GUI is shown in FIG. 21.

The capability to subscribe or unsubscribe on behalf of the vendor contact may be made available under the email address field. When adding a new contact, this may default to checked (e.g., a Subscribe to email” box may be checked by default).

After the notification has been sent to a vendor, the contacts section of the fulfillment vendor support may display their user status and if the vendor has enrolled. If a vendor become locked out, their account may be unlocked and their password may be reset. As part of their enrollment, the vendor users will be required to provide a job description. This information may be provided under the contact information on fulfillment vendor support. This information may not be editable by DC Admin users and may not be included when adding a new contact.

If a new contact is added and there are already completed assessments, an invitation to enroll may be initiated once the user is added. Vendors may not have to wait for a new assessment to be completed in order to be invited to enroll.

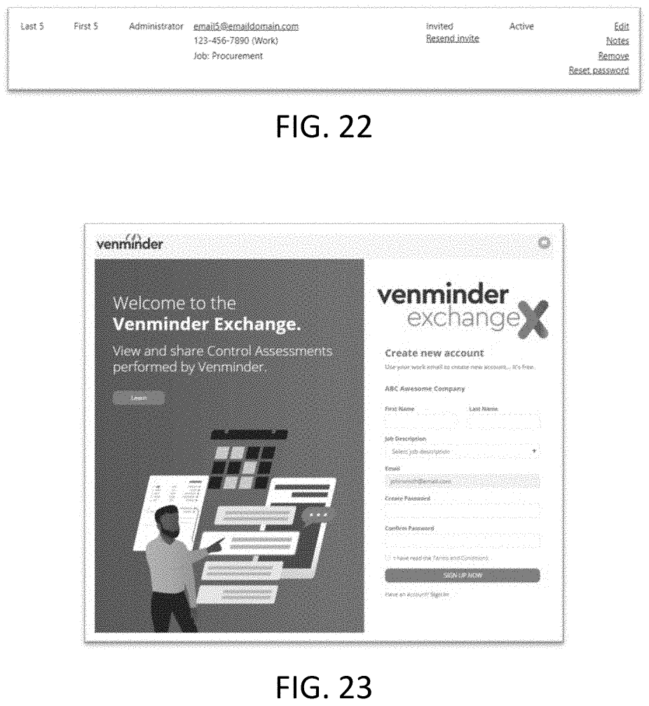

If a contact has not enrolled yet and the contact may no longer have their original invitation, an invitation email may be sent again by selecting Resend Invite. An example resend invite GUI is shown in FIG. 22.

### Vendor Invitation to Exchange Module

Email Invitation.

In some embodiments, at the time the Exchange module is released, an email notification may be sent to the vendor contacts to educate them on the new platform. A link may be provided for the vendor(s) to create their account so they may see the completed assessments. If a vendor does not wish to participate, there may be an unsubscribe link in the email to update the vendor's status from subscribed to unsubscribed. The vendor may no longer receive any emails regarding control assessments.

Enrollment Form.

When a vendor receives an email notification of the initial release or the completed assessment notice, a link will be included in the email that takes them to the enrollment form. An example create new account GUI is shown in FIG. 23.

In some embodiments, the first name, last name and email address may be prefilled. This information may be based on the contact information stored in fulfillment vendor support module. In some embodiments, the email may not be editable, but the first and last name may be editable. If the vendor edits their name on the enrollment form, that change may be reflected on fulfillment vendor support module.

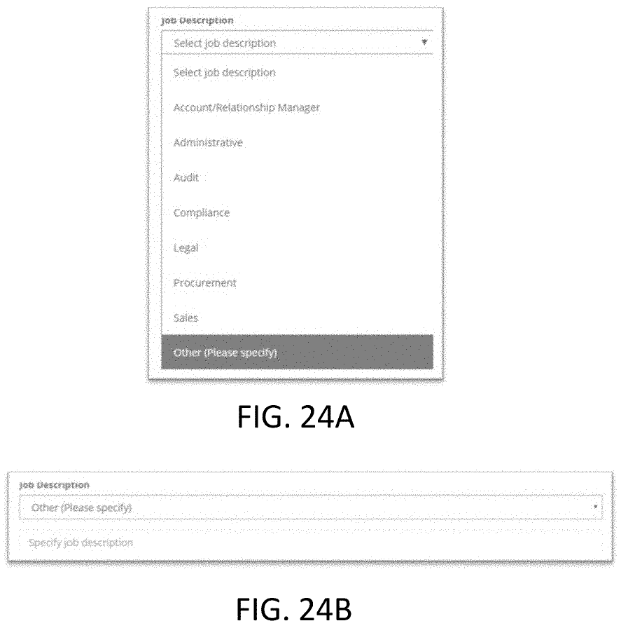

In some embodiments, the job description selected during enrollment may be visible on the vendor fulfillment support page but may not be editable. If the vendor selected “Other”, a text box field may be presented for input of a job description. An example job description GUI is shown in FIG. 24A and 24B.

When creating a password, the password requirements may be Minimum 8 characters; At least 1 number; At least 1 special character; At least 1 capital letter; At least 1 lowercase letter.

The submit button may be disabled until all fields are entered. The terms and conditions may be updated so they apply to the vendor experience versus a client experience. Once submit has been entered, a confirmation email may be sent and the vendor will be routed to the log in page. The next email regarding a completed assessment may include a link that takes the vendor to the log in page rather than the enrollment page. If the vendor clicks the link in the original email and the vendor user open at the enrollment page, the system may provide a message stating that if the vendor user attempts to enroll again advising the vendor already has an account.

### Vendor Experience Exchange Module

Welcome Modal

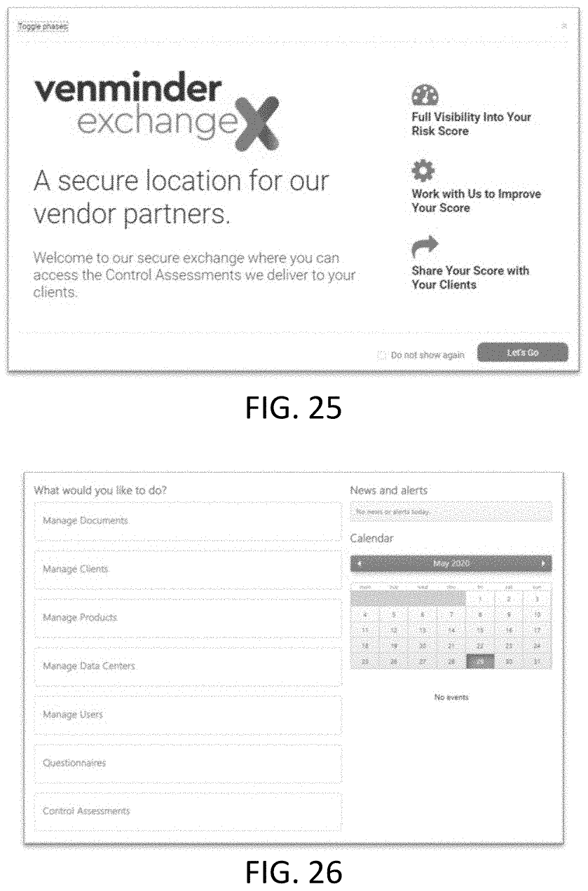

When a vendor logs in to view their assessments, they may be prompted with a Welcome Modal that provides a quick overview of what to expect. This modal can be closed by selecting the X at the top or the Let's Go button. In some embodiments, there may be an option to no longer show the modal. An example Welcome GIU is shown in FIG. 25.

Multiple Account Management

In some embodiments, the system may provide two vendor user experiences. In some embodiments, if a vendor has been asked to complete a questionnaire for a client, when the vendor enrolls for control assessments, the vendor log-in screen may provide a GUI or widget to ask which experience the vendor user may want to see. The options may include a Control Assessments modal or a Vendor Questionnaire Account modal.

If a hosted vendor enrolls for control assessments, a vendor use may experience no change to their log in compared to other modals. A new tile may be added to their home page and menu panel for access to the assessments. An example menu panel GUI is shown in FIG. 26.

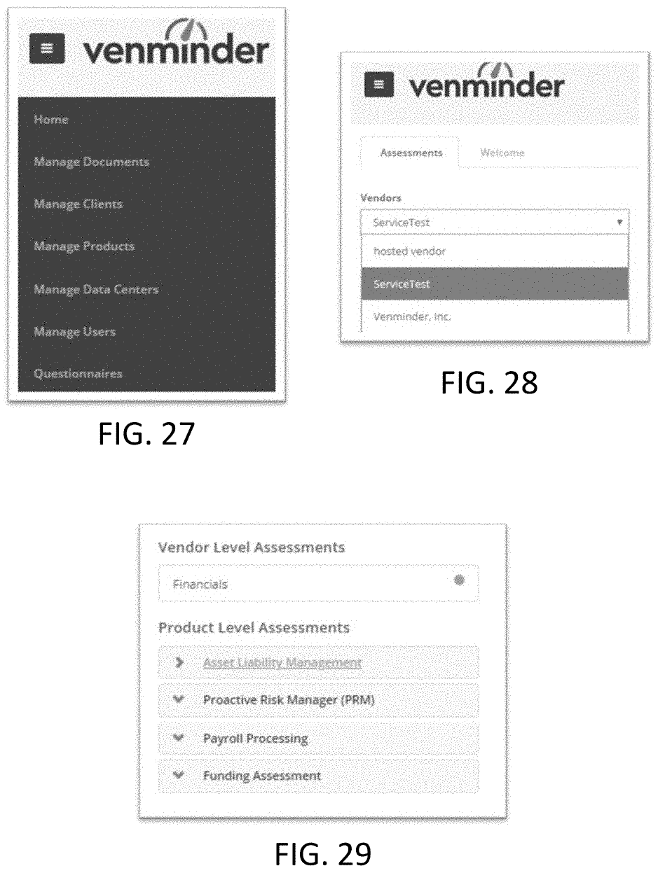

If the hosted vendor user navigates to Control Assessments, the tiles visible when they log in may be available in the menu on the Control Assessments page. An example menu panel (Control Assessments) GUI is shown in FIG. 27.

In the instance where a vendor contact is listed for more than one vendor, the vendor or vendor contact/user may be provided with the capability to select which vendor assessments they want to review from a drop-down menu. The vendors may be in alphabetical order and will allow a user to easily toggle between their vendors. When a vendor contact receives a notification of a completed assessment and the vendor contact logs in using the link within the email, the vendor and product will be selected for them. If the vendor contact logs in directly from the log in page, the vendor selected will be the first one in the drop-down list with the first available assessment highlighted. An example assessments GUI is shown in FIG. 28,

Control Assessment List

In some embodiments, the following assessments are eligible to be provided to a vendor: Business Continuity and Disaster Recovery Assessment; Service Organization Controls (SOC) Assessment; Point-in-Time Cybersecurity Assessment; and Financial Health Assessment.

If a vendor has not had a financial health assessment completed, the Vendor Level Assessments section may not be displayed. If an assessment has not been completed on a product, that product may not be displayed in the Product Level Assessments section.

The products section may be in alphabetical order and may be expanded and collapsed by clicking on the product name or the arrow. A dot to the right of the assessment name may be provided to match the color of the overall assessment score. An example vendor level assessments GUI is shown in FIG. 29.

If the vendor accessed the system using the link in the completed assessment email, when the vendor user logs in the product, assessments referenced in the email may be highlighted. If there are multiple assessments referenced in the email, when vendor user log in, the system will default to the first assessment for the product listed first.

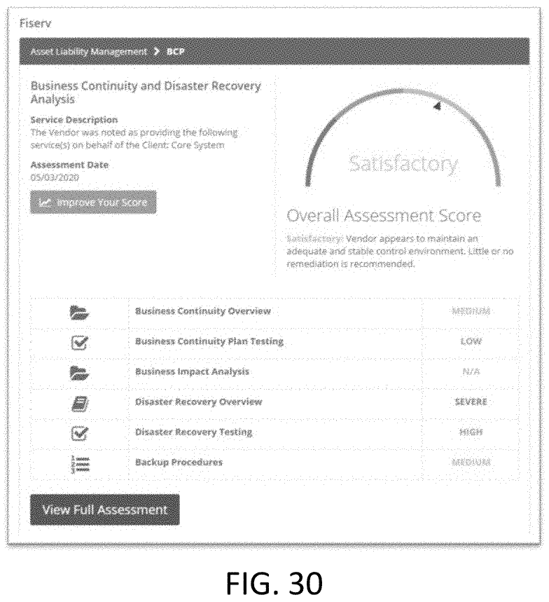

When an assessment is selected, the row pertaining to that assessment will highlight, and the details of that assessment may appear to the right. Each section of the assessment may be displayed with that section's score. The option to view the entire assessment may be provided in this section as well. An example assessment overview GUI is shown in FIG. 30.

Preview Assessment

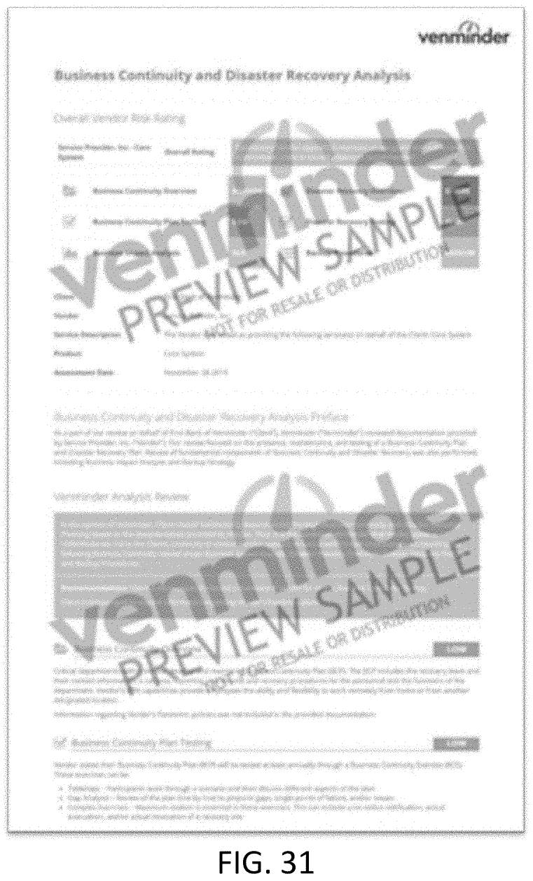

By selecting View Full Assessment under the section scores, a vendor user may see a watermarked version of a completed assessment. This may give the vendor user an opportunity to see how their product rated and if there are any areas that need improvement. An example assessment is shown in FIG. 31.

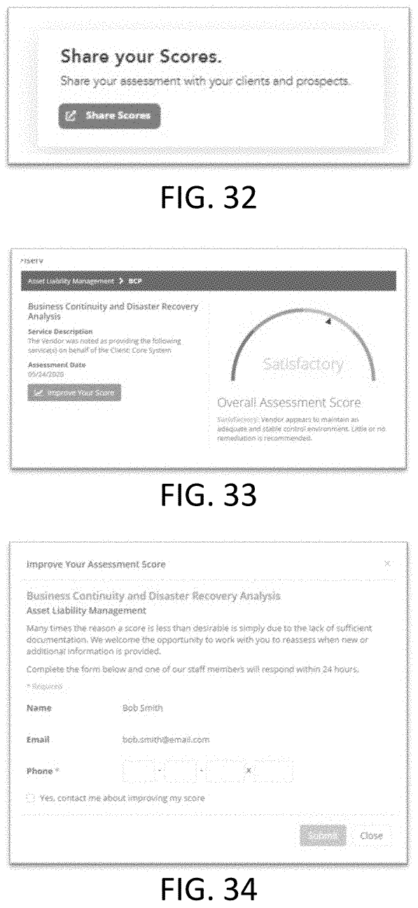

Share link. If a vendor user chooses to share their scores with their clients or prospects, a link to enable such sharing may be displayed on the top of the page. An example share your scores widget/GUI is shown in FIG. 32.

By clicking the Share Score button, a (vendor) user may be taken to the Share Your Scores tab. Here, assistance may be provided (in a GUI) with how to share the scores with an example email template. This tab may explain the benefits of sharing the scores and provide information relating to the scoring process.

Improve Your Score

As a vendor user navigates through one or more assessments, any score that is less than “Confident” may include the option to ‘Improve Your Score’. By selecting this option (e.g., by clicking on an appropriate button), a modal may open so that a (vendor) user may provide contact information. An example overall score-improve score widget/GUI is shown in FIG. 33. An example improve score-contact information GUI is shown in FIG. 34.

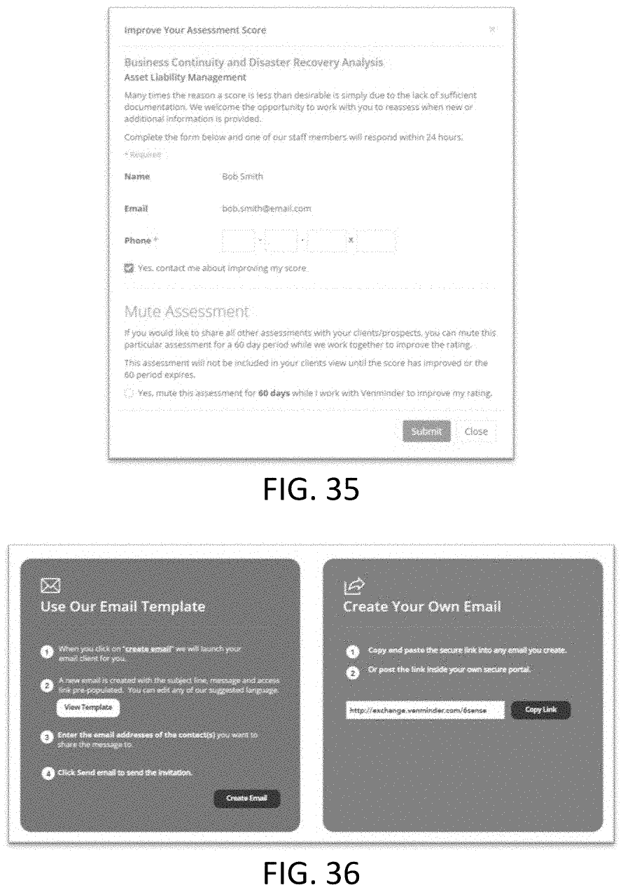

Clicking the submit button may trigger a notification to the Vendor Relationship Management team. The team may reach out to the vendor to explore methods to improve their control assessment rating. If a score pertaining to a vendor is less than Confident, the vendor can elect to ‘mute’ that assessment for, e.g., up to 60 days while they work with the system provider to improve their rating. The vendor can still share control assessments scores by sending a link, but muted assessments may not be visible to their clients. An example improve score-contact information GUI-Mute Assessment is shown in FIG. 35.

About Tab

The about tab may be displayed to explain the purpose of the provided Exchange module and how access to these completed assessments can benefit the vendor. Some assessments may be ready to be shared, and some may need some improvement.

The control assessment review and scoring processes are briefly described herein. If the scores provided are ready to be shared, an option to do so may be provided. The notification process of new completed assessments is detailed along with contact information for provider if assistance is needed or if a (vendor) user would like to add one of their colleagues to receive notification as well.

Share Your Scores

This tab notifies the vendor of the benefits of sharing their scores with their clients or prospects. Two methods of sharing their scores may be provided.

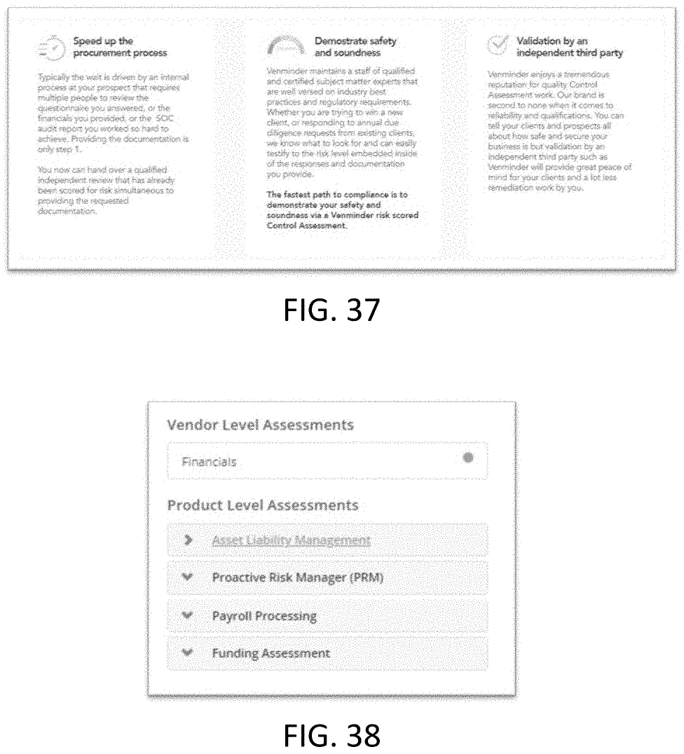

An email template may be provided that includes a link for a vendor's clients. If the link would be more beneficial to add to a secure portal or included in a different email, a simple copy link may be provided. An example Email GUI is shown in FIG. 36. The scoring process may be provided and reasons why sharing the scores is the right move. An example benefits of sharing window is shown in FIG. 37.

### Non-Contracted Client Experience-Exchange Module

Control Assessment List

The control assessments list may be identical to the vendor's experience.

If the vendor has not had a financial health assessment completed, the Vendor Level Assessments section may not be displayed. If an assessment has not been completed on a product, that product may not be displayed in the Product Level Assessments section.

The products section may be in alphabetical order and may expand and collapse by clicking on the product name or the arrow. In some embodiment, a dot to the right of the assessment name may be provided to match the color of the overall assessment score. An example vendor level assessments GUI is shown in FIG. 38.

If a non-contracted client uses the link provided by their vendor to log in, that vendor/product may be pre-selected. If a (client) user chooses to log in directly from the log in page and more than one vendor has shared with them, the first vendor in an alphabetical list may be selected. When an assessment is selected, that row pertaining to the assessment may be highlighted, and the details of that assessment may appear to the right. Each section of the assessment may be displayed with that section's score. The option to view the entire assessment may be provided in this section as well.

Ability to Search Fulfillment Vendor Library

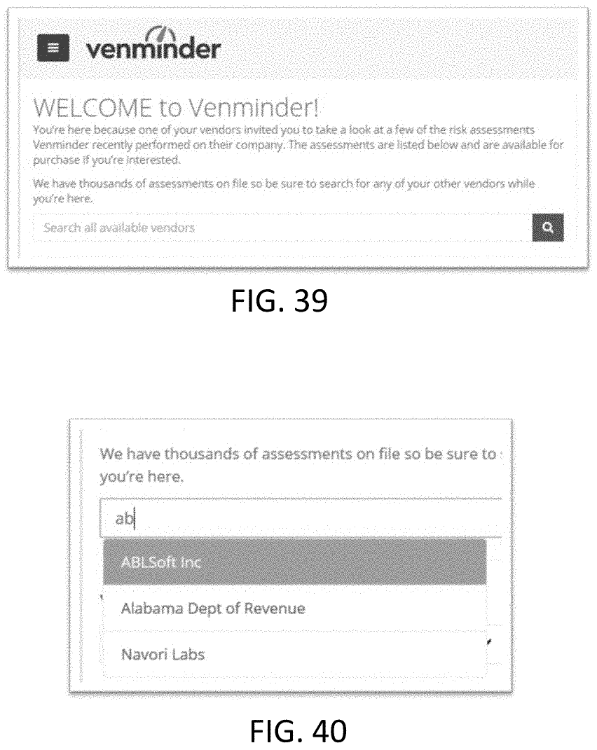

When a non-contracted client has enrolled to view their vendor's assessments, a (client) user may search for other vendors that shared their assessments directly. A library of completed assessments for other vendors can be viewed and/or purchased. An example welcome GUI is shown in FIG. 39. As the name of the vendor is typed, predictive text may show results based on the entry in the search box. When a vendor is selected, the available products and assessments may update on the page. An example vendor selection GUI is shown in FIG. 40.

Ability to Toggle Between Vendors

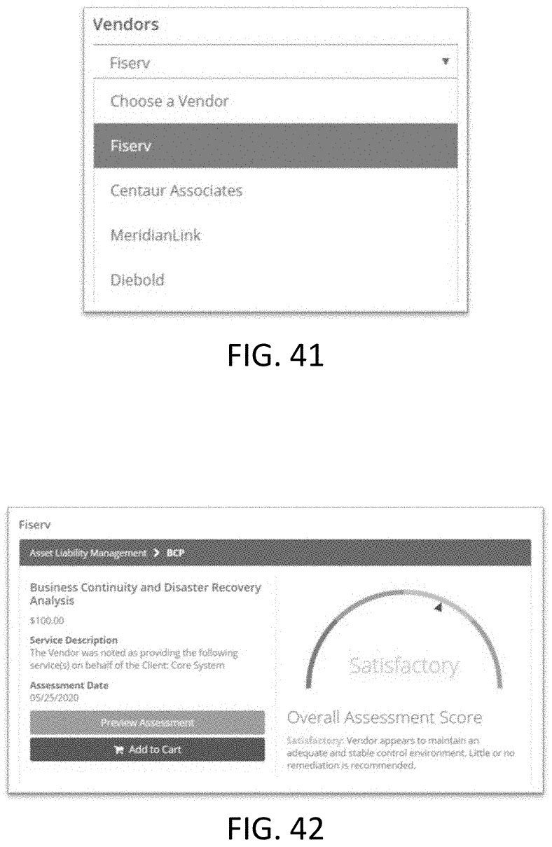

Once a non-contracted client has been provided with assessments by multiple vendors, a drop-down menu may be displayed so that a user may toggle between all vendors'shared assessments. If the non-contracted client user searches for other vendors using the search bar at the top of the page, those vendors may be added to that drop down for quick view later. An example drop down menu GUI is shown in FIG. 41.

Capability to Order Control Assessment

A non-contracted client may be able to see a preview of the first page of a completed assessment. This may provide a chance to see what a purchase may look like. Once the user is ready to place an order, may do so by selecting Add to Cart. An example order GUI is shown in FIG. 42.

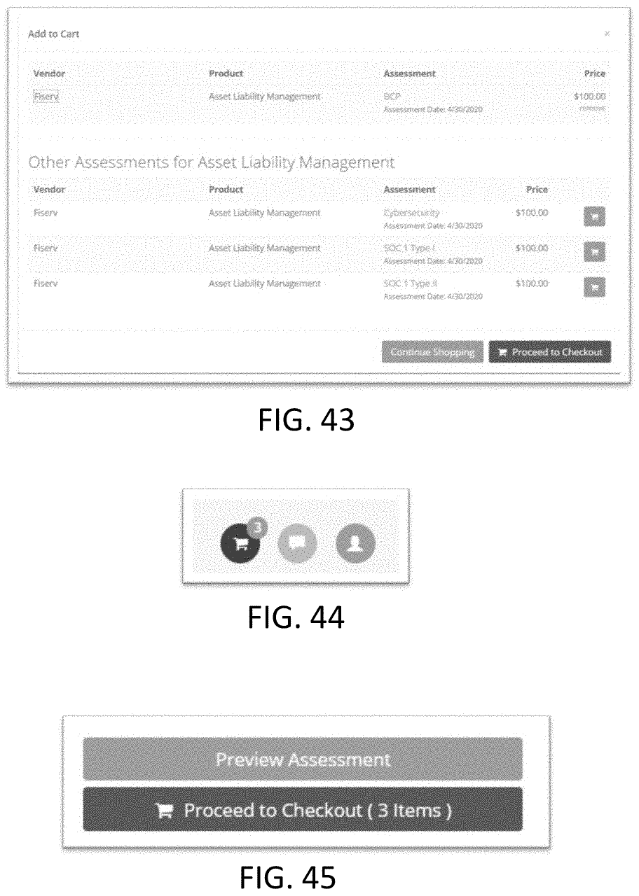

The Add to Cart modal may show what is being added to the cart and may provide the capability to remove items. A list of any other completed assessments for the same product may be included. Selecting the cart icon may add that (selected) assessment to the cart. An example order/add to cart GUI is shown in FIG. 43.

By clicking on the type of assessment, the Add to Cart modal may be closed and the high-level details of that assessment may be opened. From here, a user may continue shopping or proceed to check out. The number of items added to the cart may be indicated on the shopping cart icon on the top of the page. An example shopping cart widget is shown in FIG. 44.

If an assessment is currently in the cart, the Add to Cart button may change to Proceed to Checkout. This change may be an indicator that this assessment is already in the cart. An example proceed to checkout widget is shown in FIG. 45.

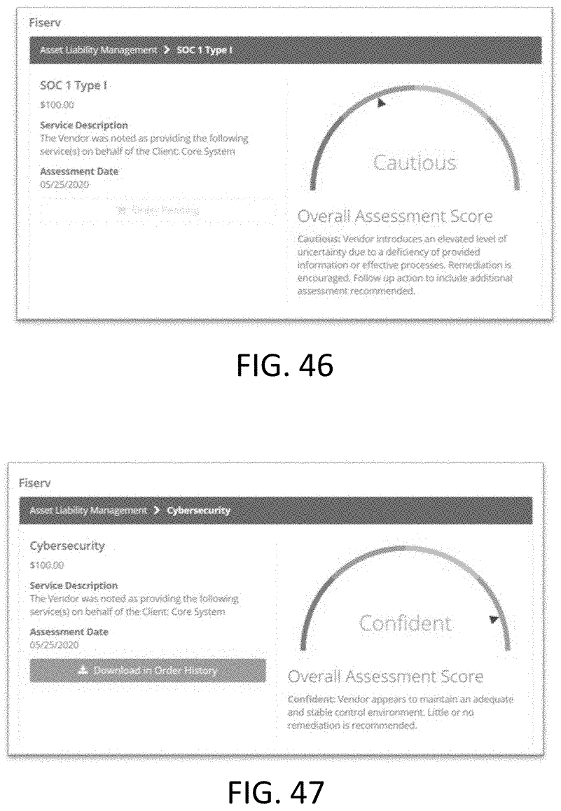

When a new assessment has been completed on a vendor, but the non-contracted client has an older version in their cart, the cart/assessment may not be updated. The user may need to know to remove the item in their cart and replace it with the newer version. While the order is pending completion, the Add to Cart button may be changed to Order Pending and checkout may be disabled. An example order GUI with order pending is shown in FIG. 46.

Once the assessment has been completed and delivered to the non-contracted client, the Add to Cart button may be replaced with Download in Order History. This is an indicator that the assessment has already been purchased. Clicking that link may take a client user to their Order History. An example order GUI with download in order history is shown in FIG. 47.

Checkout Process and Payment Integration

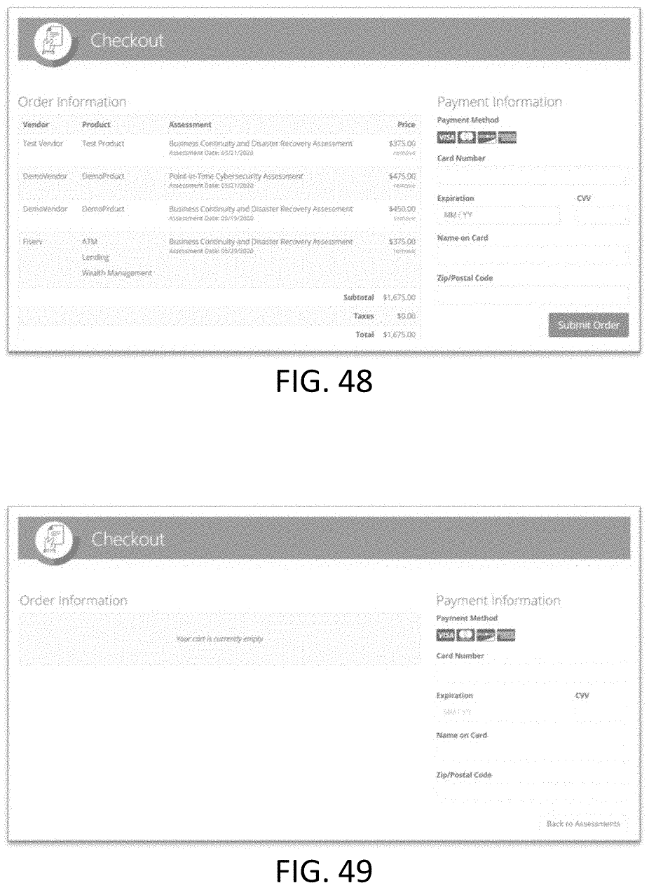

After the cart has been updated with all items that are ready to purchase, and the Proceed to Checkout functionality is selected, a review page may be displayed where payment information is requested. The order information section may include details including vendor's name and product and which assessments were chosen for purchase. The total of each assessment and the capability to remove may be provided. An example checkout GUI is shown in FIG. 48.

When credit card information is submitted, the information may be passed to a payment processing module (e.g., Braintree) for validation. In some implementations, the system provider may not store payment information. If the credit card information is valid, it will be vaulted, and a token may be provided. If the card information cannot be validated, the user may receive a message that the card was invalid and that the user may try again. If all assessments are removed, a notice will be provided, and the Submit Order button will change to Back to Assessments. An example checkout GUI with empty cart is shown in FIG. 49.

Order History

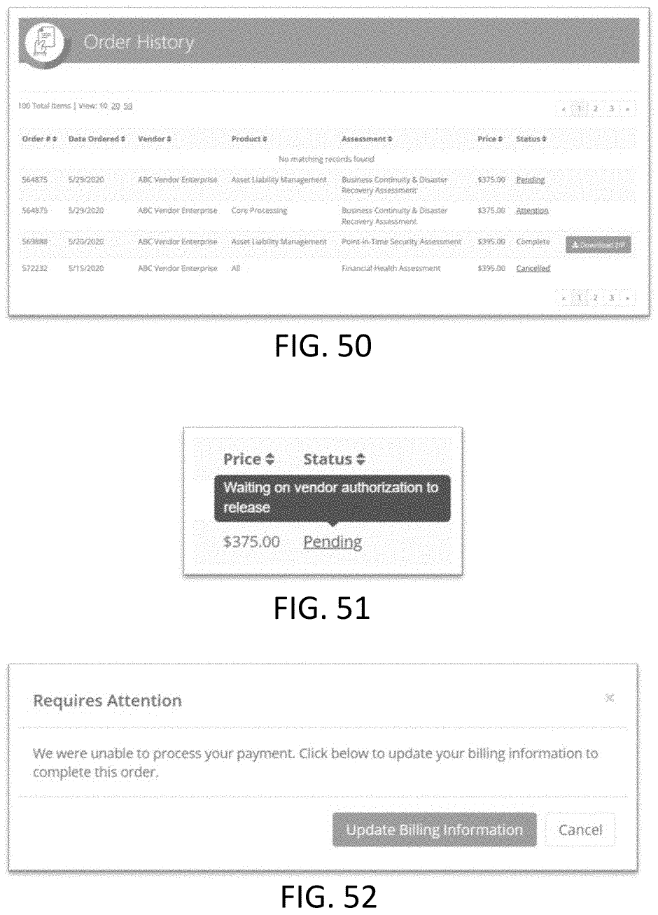

In some embodiments, an Order history module is provided where a non-contracted client may view the status of orders that have been submitted by any user with the user's company. An example Order History GUI is shown in FIG. 50.

While an assessment is being worked on, the status may read Pending. A tool tip may be available to advise that the user or system is waiting for vendor authorization prior to release. An example status widget is shown in FIG. 51.

In some embodiments, an assessment status of Attention indicates that the payment was not approved when an attempt to deliver was made. When a user clicks on Attention, a modal opens to explain that the system was unable to process the payment. By clicking on Update Billing Information, a user may be routed back to the Checkout page so card information can be submitted again. An example Requires Attention widget is shown in FIG. 52.

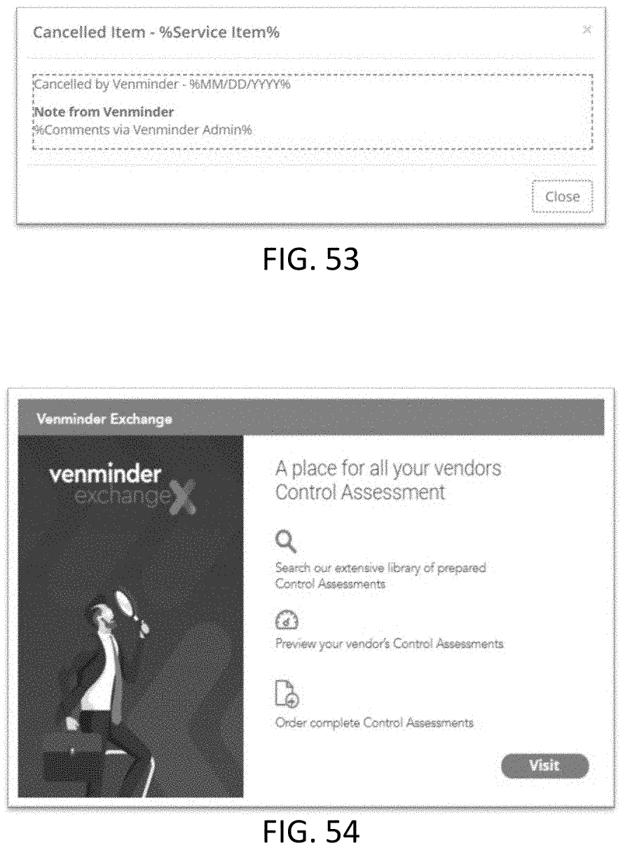

If an assessment is completed and the payment was successful, the status will be set to Complete. The assessment and any supporting documents can be downloaded in a zip file. An assessment may be cancelled prior to delivery. If this occurs, the status of the assessment may be set to Cancelled. When Cancelled is selected, a modal may open to provide the date the assessment was cancelled and notes (generated by) the system regarding the reason for cancellation. An example Cancelled item widget is shown in FIG. 53.

### Non-Contracted Guest Client Experience-Exchange Module

Dashboard Widget to Access Exchange Module

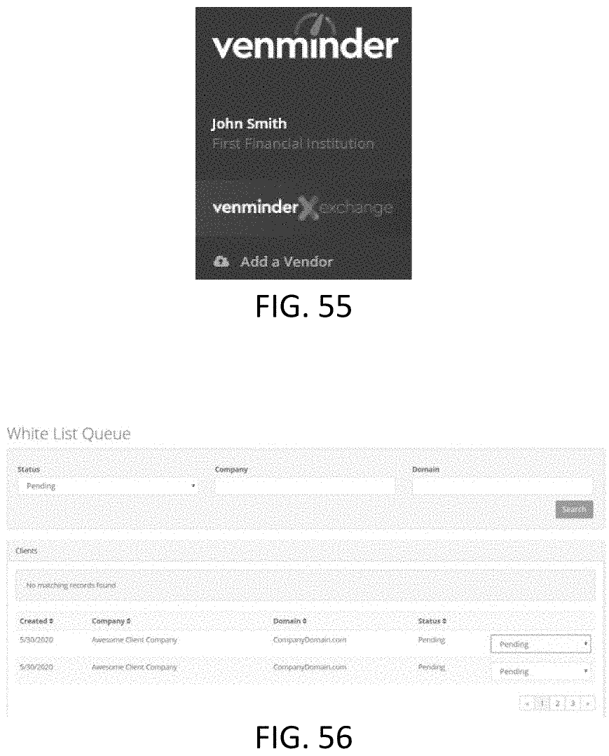

A guest user that is invited to view a vendor's assessment may not have any change to their log-in experience compared to other provided systems as described herein. Once a (guest) user logs in, the due diligence widget on the main dashboard may be updated to allow access to the assessments. In some embodiments, Control Assessments may be added as an item in the menu panel to allow access as well. An example Exchange welcome GUI is shown in FIG. 54. An example Exchange access widget is shown in FIG. 55.

White List Queue

When a vendor invites one of their clients to view their assessments and a (client) user attempts to create an account, the system or a system user may review their (client) company name and (client) domain to ensure they should be granted permission to purchase assessments. The (client) company name and domain may fall into a queue and an authorized system provider representative may review their information and either approve or deny. A (client) user will be able to log in but the ability to purchase and download an assessment may be determined by their status in the whitelist queue.

An admin user for DC Admin may have been provided the capability to permit access to the whitelist module.

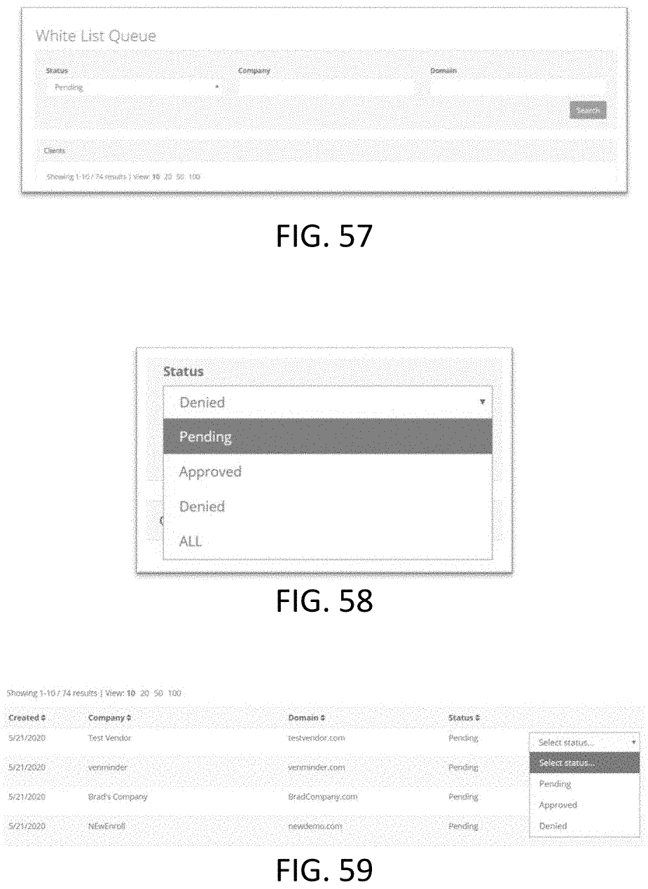

The whitelist queue may provide a list of all domains that were not pre-approved by the system provider as approved. If the domain/company isn't already in the provider data base, approval or denial of access may be provided here. An example White List Queue GUI is shown in FIG. 56. The default view may be 10 rows with the capability to show more results per page. An example White List Queue GUI displaying more than 10 results is shown in FIG. 57.

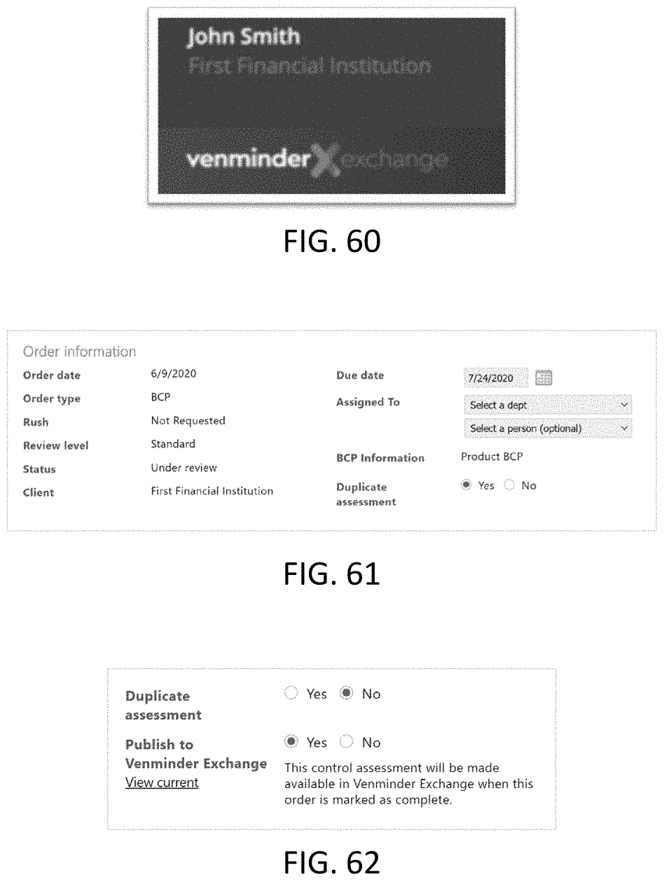

Of the items in this list, a user may search by status in a drop-down menu, or the Company or Domain via a text box. An example Status widget is shown in FIG. 58. Each entry may provide the options to either approve or deny. An example item list GUI with status selection widget is shown in FIG. 59. If the domain is denied, a user may receive a notification to let the user know that the user may not be able to continue with any purchases. An example Exchange widget is shown in FIG. 60.

Client Support for Non-Contracted Clients

Once a company/domain has been approved, the company/domain may be entered into the system and searchable in client support. Any users enrolled with this company and domain combination will be added to the users sections within client support. In some embodiments, their account type may be Non-Enterprise as an indicator that they do not have a contract with the system provider. In some embodiments, if there are any orders placed by these non-contracted clients, a link may be provided in client support that will route the client users to their Order History.

### System Admin: Executive Level Analysis and Review Queues

Duplicate Control

In some embodiments, the duplicate checkbox when modifying an order in the Review Queue may be converted to a radio button control to capture a distinct yes vs. no value from the system Admin user. This data may be used to create (more) accurate metrics, e.g., to understand how often control assessments are reused. The duplicate control may be converted into a required field. Validation may be in place to inform a user that a value is required to save the view. An example Review Queue: Duplicate Control GUI is shown in FIG. 61.

Publish Control

In some embodiments, if a control assessment order is not a duplicate, then the option to Publish may be made available for selection by a user.

In some embodiments, if a Financial Health Assessment (FHA) contains client restricted documents, then publish option may not be available.

The system Admin user may have the capability to preview the control assessment currently published, to verify whether the current order should overwrite. If there is a control assessment already published to the Exchange module that share the same properties of the current order (fulfillment vendor product and control assessment type), then a link to preview may be made available. If the control assessment has an in-app view, clicking on an appropriate link may open a new browser tab with a copy of the published control assessment. If an in-app view is not available, then clicking “Preview” may cause download of a copy of the published control assessment.

In some embodiments, Financial Health Assessments linked to one or more documents marked as client-restricted may not be eligible for publish to the Exchange module. The option to publish may not be available for selection. An example Review Queue: Publish control and preview link widget is shown in FIG. 62.

ELA Queue: Duplicate and Publish Control

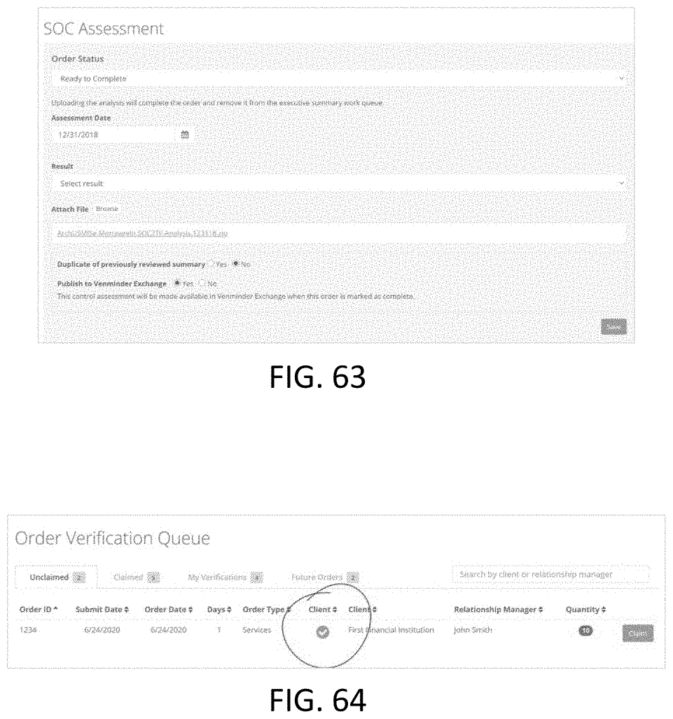

The control to mark an order as a duplicate and whether to publish the control assessment to the Exchange module may also be available when modifying an order within the ELA Queue. Any values recorded from the Review Queue may be carried over to this area. An example ELA Queue: Duplicate and Publish Controls GUI is shown in FIG. 63.

If the assessment date recorded for this order is older than the assessment date of the currently published control assessment, the system will display a warning. The user can still proceed with the publish if they choose.

Completing an ELA Order Marked for Publish

When a control assessment order marked for publish is completed, the following areas may be updated with the newly published assessment: Quick Delivery Widget for contracted clients; Exchange portal for non-contracted clients; Exchange portal for vendors. The previous control assessment may no longer be available within the Exchange module, however any instances in which the assessment was added to a user's cart prior to publishing may remain in the cart for purchase.

### System Admin: Order Verification Queue

Contracted Client Indicator

For orders displayed in the system Admin Order Verification Queue, a checkmark indicator may be displayed to denote contracted clients. An example Order Verification Queue: Client Indicator is shown in FIG. 64.

Verify Exchange Order

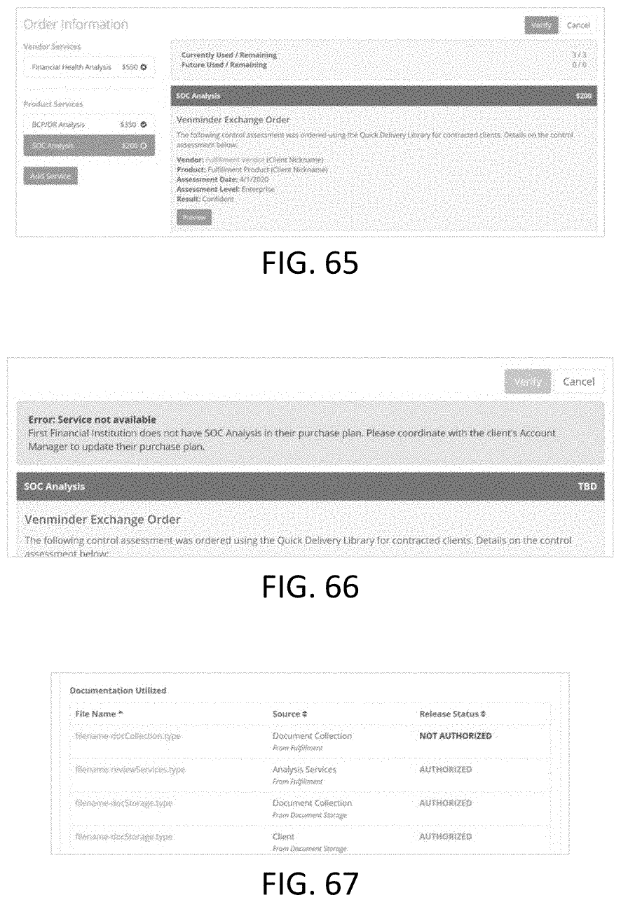

Since orders submitted via the Exchange module reference a particular control assessment, the verification references details regarding the control assessment. The system may also indicate whether an order originated from a contracted or non-contracted client. An example Verify Order: Exchange Order Information GUI is shown in FIG. 65.

For contracted clients that ordered a control assessment not yet in their purchase plan, the price may be represented with a TBD. A warning may be displayed prompting the system Admin user to coordinate with the client's Account Manager to add the control assessment and its pricing to the purchase plan. The system Admin may not be able to verify the control assessment until the purchase plan is updated. Otherwise, the order may be cancelled. An example Verify Order: Purchase Plan Warning widget is shown in FIG. 66.

Documentations used for the control assessment may be displayed, each indicating whether the client is authorized or not authorized access to the document. Authorization may be based on the release status of the document stored in Fulfillment Vendor Support. An example Verify Order: Documentation Utilized widget is shown in FIG. 67.

An area for comments, as found in non-exchange verifications, may remain available for notes from the system provider team.

Complete Exchange Order via Order Verification

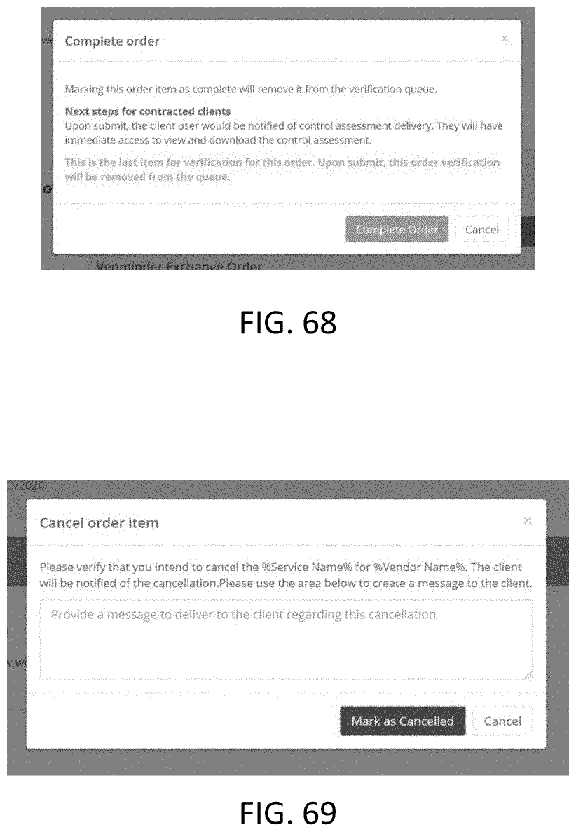

If all documentation utilized for the control assessment is authorized, Admin users may now have the ability to complete orders directly from the Services Verification Queue. This procedure may constitute an efficiency gain for the team because these types of orders are no longer required to move through the Executive Level Analysis or Review Queues. An example Verify Order: Complete Order widget is shown in FIG. 68.

Cancel Exchange Order via Order Verification

Admin users may have an area to provide a note to a client when cancelling an order from the Verification Queue. In some embodiments, this note area may only be available from the Executive Level Analysis queue. The cancellation note will be displayed to the contracted or non-contracted client. An example Verify Order: Order Cancellation widget is shown in FIG. 69.

### System Admin: Executive Level Analysis

ELA Queue

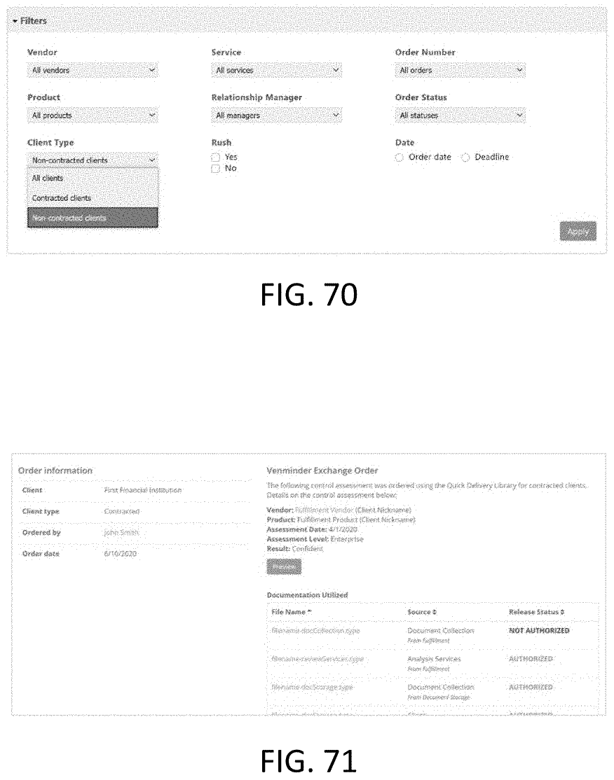

The Executive Level Analysis queue may have a filter for client type. A user may use this filter to display/hide contracted or non-contracted clients in the queue. An example ELA Queue: Client type filter GUI/widget is shown in FIG. 70.

Manage Exchange Order

Similar to the Order Verification Queue, managing orders originating from theExchange module may see specific information regarding the control assessment ordered. The page may indicate the client type (contracted vs. non-contracted) and documentation linked to the control assessment with authorization status. An example ELA Queue: Modify Exchange Order GUI is shown in FIG. 71.

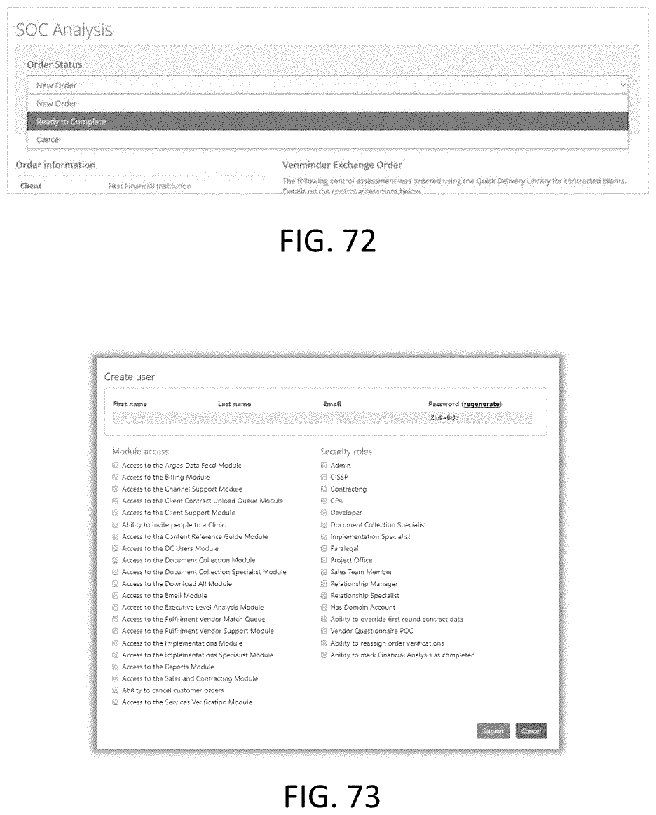

Available statuses beyond ‘new’ status for Exchange orders may be limited to either marking as completed or canceled/cancelling the order. The option to complete the order may only be available when all documentation utilized as marked as “Authorized.” An example Modify ELA Order: Statuses for Exchange Orders GUI is shown in FIG. 72.

When an Exchange order is marked as complete, the system may perform the following actions based on client type. For Contracted clients, the control assessment may be delivered to the client (order history and Document Storage) and the user may be notified via email. For

Non-contracted clients, the system may perform a transaction call to a payment processing module (e.g., Braintree). When a successful credit card transaction is confirmed, then the control assessment is delivered to the Exchange module order history. The user may be notified via email (e.g., an automatically generated email).

### System Admin: Fulfillment Vendor Match Queue

DC Users: Module Access

Access to the Fulfillment Vendor Match Queue may be made available to the Module Access list for DC Users (e.g., one or more users that are part of the system provider, e.g., employees of the system provider). The ability to access and use the Fulfillment Vendor Match Queue may be restricted by this new access. A new security role may be provided. An example DC Users: Module Access GUI is shown in FIG. 73.

Fulfillment Vendor Match Queue

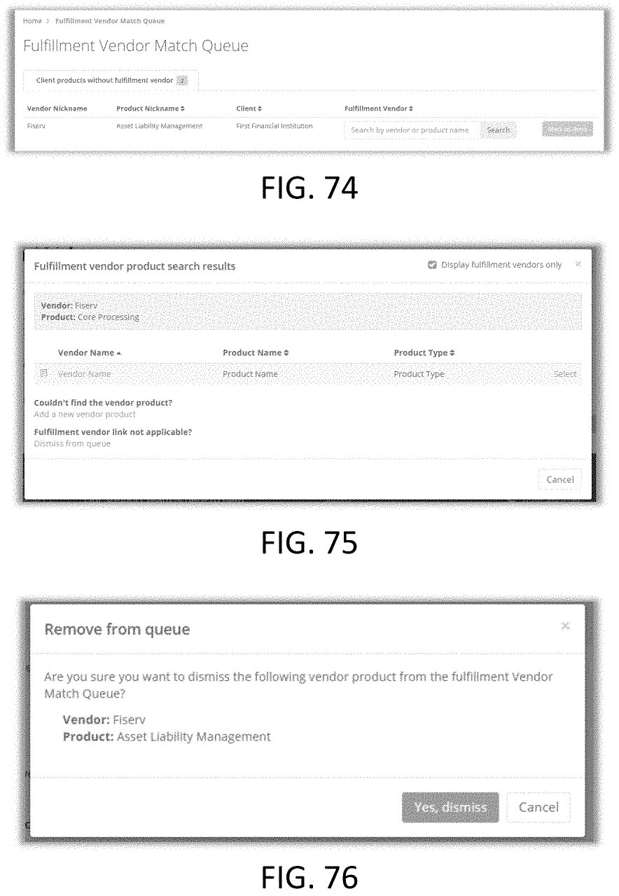

The Fulfillment Vendor Match Queue may be used to address any client vendor products that are not associated with a fulfillment vendor in the application. Associating the vendor products with fulfillment vendors may be needed to be able to match available assessments for a client to display in the Control Assessments-Quick Delivery Library widget. The queue may display a list of all client vendors and products that are not associated with a fulfillment vendor. An example Fulfillment Vendor Match Queue widget is shown in FIG. 74.

Any user that has access to the queue may be provided with the ability to search for fulfillment vendors and products. The user may enter text into the search bar and select the Search button. This may open the Fulfillment vendor product search results modal. Users may then select a fulfillment vendor product, may add a new fulfillment vendor product, or dismiss from the queue. An example Fulfillment vendor product search results widget is shown in FIG. 75.

Dismiss from queue may be an option in this modal. Selecting the Dismiss from queue may open a Remove from queue modal. When the user selects the Yes, dismiss-button, the line item may be removed from the Fulfillment Vendor Match Queue and the client's vendor product may not be associated with a fulfillment vendor product. An example Remove from queue widget is shown in FIG. 76.

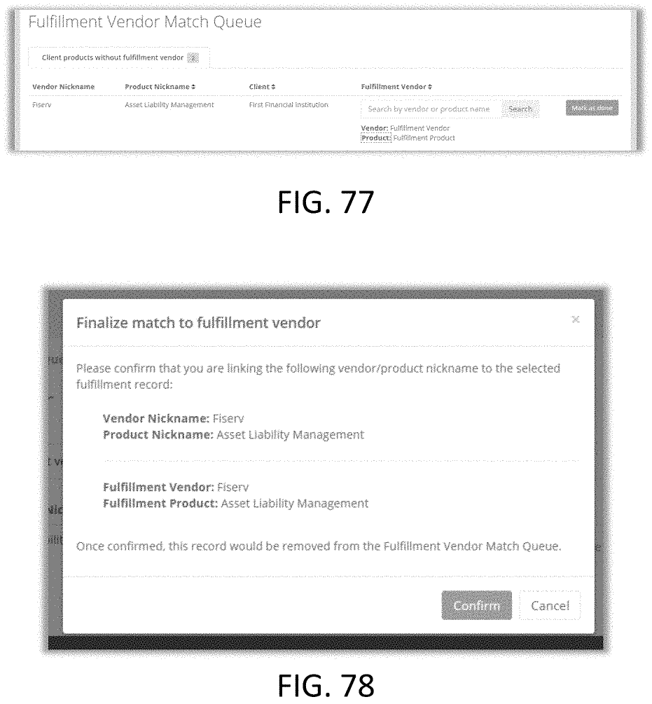

When a fulfillment vendor product is selected and saved, the fulfillment vendor product information may be added to the row. Subsequently, the Mark as done button may be rendered active/selectable. When the button is selected, a modal may be displayed to confirm the information. Once confirmed, the client's vendor and product may be matched to the fulfillment vendor product. The row will be removed from the Fulfillment Vendor Match Queue. An example Fulfillment Vendor Match Queue widget is shown in FIG. 77. An example Finalize match to fulfillment vendor modal-Confirm widget is shown in FIG. 78.

Contracted Client Experience for Exchange module

Main Menu

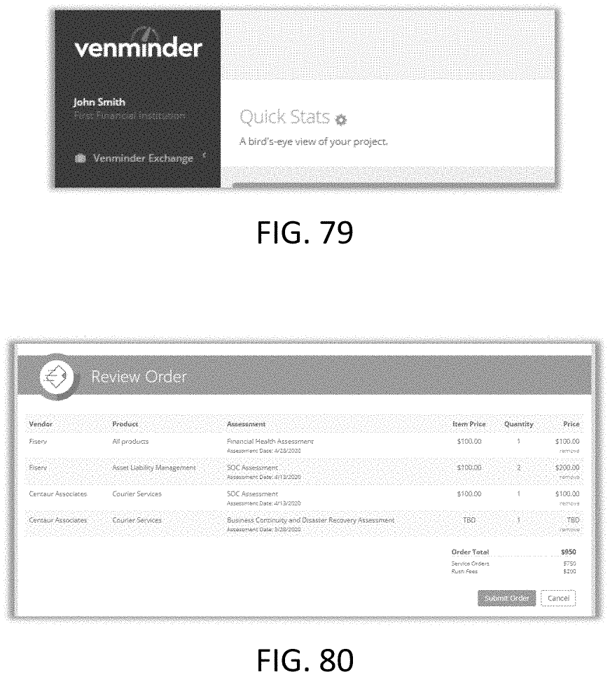

The Main Menu options may include Services module or an Exchange module. On each page within the application, the menu item may include the Exchange module. The function of the link may be to direct the user to the Place an Order page or Order History page. An example Menu Item: Exchange GUI/widget is shown in FIG. 79.

Cart

When a user select the cart icon, the Review Order page may be displayed. The Review Order page may include a vendor level view or an assessment level view. The view may be expanded to list each assessment type in the order with the assessment type having its own separate line item. If there are multiple assessment orders for a vendor product, then the vendor product may be duplicated in the list. In some specific embodiments, this may allow a user to delete each individual assessment from the order when otherwise the user would have to delete the entire order for the vendor. An example Review Order: Updated View GUI is shown in FIG. 80.

Email for Items in Cart

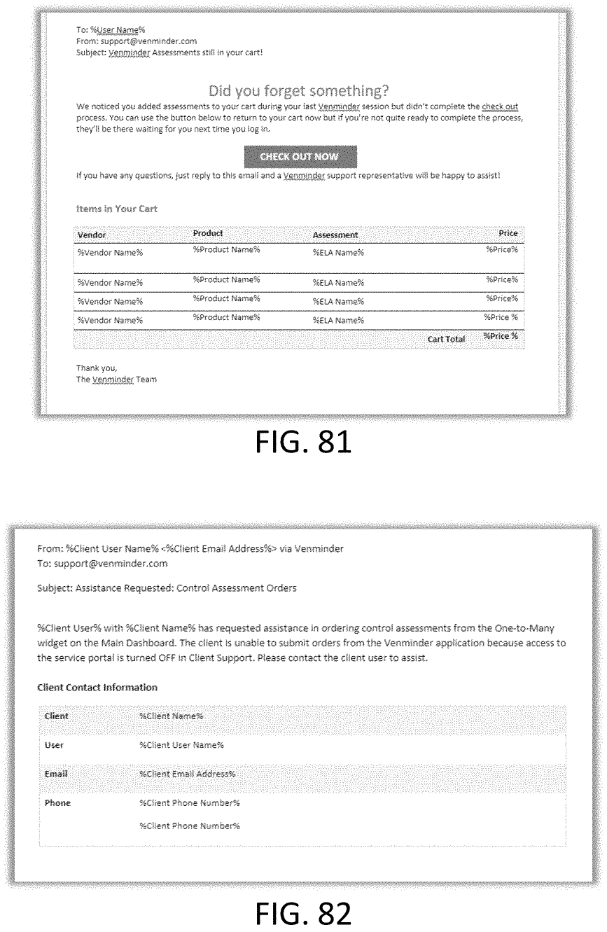

A client email may be available to notify the user when there are still assessments in their cart. The email may be sent (e.g., automatically) one time to remind the client that they left items in their cart that were not submitted. The email may run on a nightly batch so the notification may be sent the next day. An example Email Template: Assessments still in your cart! GUI is shown in FIG. 81.

Email to Contact System Provider

If a client does not have access to services, then the client may not be provided with the capabilities to order assessments from the application. The client may be provided with the capability to request assistance from the system provider's internal team to order assessments. In some embodiments, an email may be sent to provider Support. In some embodiments, the subject of the email may be Assistance Requested: Control Assessment Orders. The email may include the client's contact information. An example Assistance Requested Email Template is shown in FIG. 82.

Main Dashboard Widget: Control Assessments-Quick Delivery Library

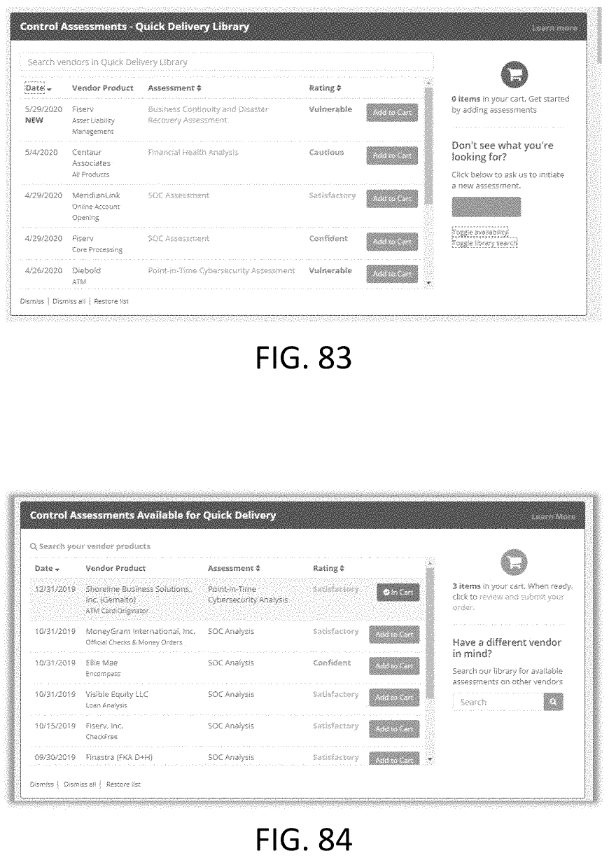

In some implementations, the system includes a Due Diligence widget or a Control Assessments-Quick Delivery Library widget. This latter widget may display assessments that have been completed for a client's vendor products based on the fulfillment vendor identified internally. The client may see the Date, Vendor Product, Assessment and Rating for the completed assessments. Any assessment that has been previously delivered to the client may not be displayed in the widget. When new assessments are completed for the client's vendor products, the assessment may display in the widget with a “New” indicator. In some embodiments, the New indicator may remain for 7 days then be automatically removed by the system. An example Control Assessments Quick Delivery Library Widget is shown in FIG. 83.

If a logged-in user has been provided with the capability to manage service orders, then a user may order directly from the widget by selecting the Add to Cart button. The assessment may be added to the cart and a message may be displayed letting the user know how many items are in the cart. Multiple users within the same organization may add the same assessment to the cart. When the order is submitted, the user that submits the order may become the owner of that assessment order. The order may be removed from the other user's cart so that it cannot be submitted twice. Once the order is submitted, the assessment may be removed from the widget. An example Add to Cart widget is shown in FIG. 84.

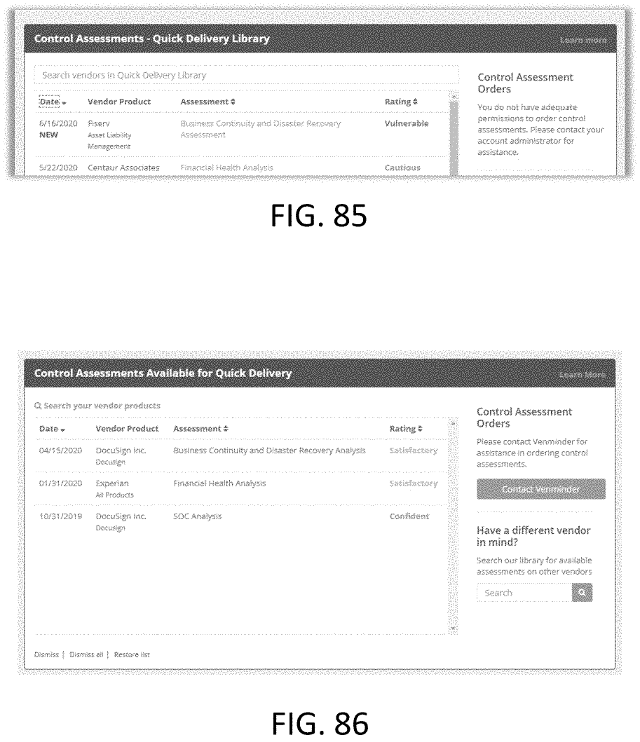

If a logged-in user has not been provided with the capability to manage service orders, then the user may not be presented with the Add to Cart button in the widget. The cart icon may be replaced with text to direct the user to contact their account administrator. An example User does not have the ability to manage services widget is shown in FIG. 85.

Clients that do not have access to services may be provided with the Control Assessments Quick Delivery Library widget. The users may not be able to add assessments to their cart. The user will have a Contact provider button, which, when clicked, may cause opening of a modal allowing the user to send a request for information. This action may trigger generation and/or sending of the Assistance Requested: Control Assessment Orders email to client support. An example Contact Provider widget is shown in FIG. 86.

Quick Delivery Library—Ability to Order All Services

When displaying assessments in the Quick Delivery Library widget, all assessments may be displayed for the client's vendor product regardless if the service is part of the client's purchase plan. The client may have been provided the capability to order services that are not in their purchase plan and the price may display as TBD. Once the order is submitted, there may be a flag in the Services Verification Queue (internal queue) that the service needs to be added to the purchase plan for the client.

Quick Delivery Library—Ability to Search Vendors

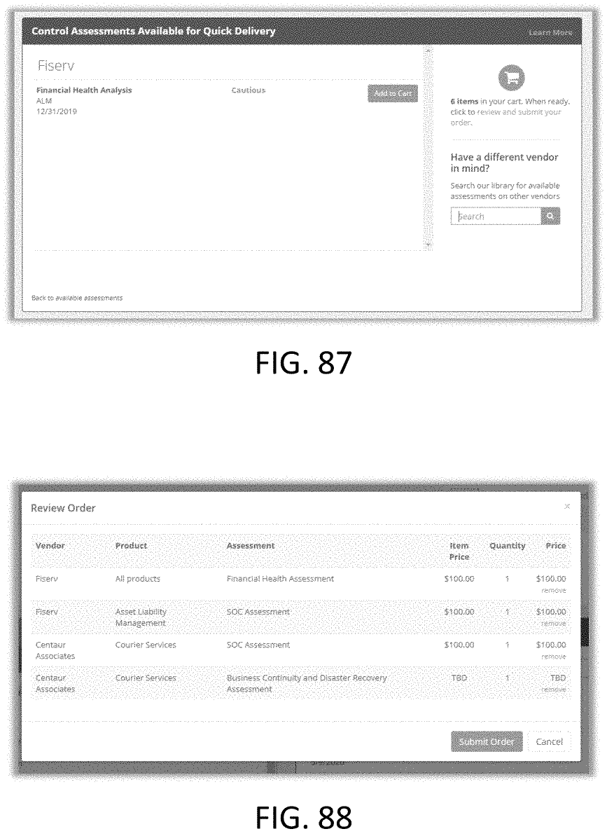

Client user(s) may be provided with the capability to search for any vendor. The search may be based on fulfillment vendor products in the provided library. Searching for vendors may return any assessments that have been completed for that vendor product. Clients may be provided with the capability to order services for vendor products that are not in the client's vendor list. In some implementations, a client may order for vendors in their list. An example Search Vendor Results widget is shown in FIG. 87.

Quick Delivery Widget: Cart Icon

When assessments are added to the cart, the cart icon may be activated for the client to select. In some embodiments, the cart may only include assessments for the individual user. When the cart icon is selected, a Review Order modal may be displayed. The Review Order modal may include all assessments that the user has added to cart including any orders from the Exchange-Place an Order page. The modal may display the Vendor, Product, Assessment, Item Price, Quantity, and Price. In some embodiments, when placing an order from the widget, the quantity may be set to 1 and cannot be changed. Users may be provided with the capability to remove any orders they added. The users may Submit Order for processing, which may move all orders in the cart to the Services Verification Queue (for internal processing/delivery). An example Cart Icon-Review Order Modal widget is shown in FIG. 88.

Vendor Dashboard—Quick Delivery Library

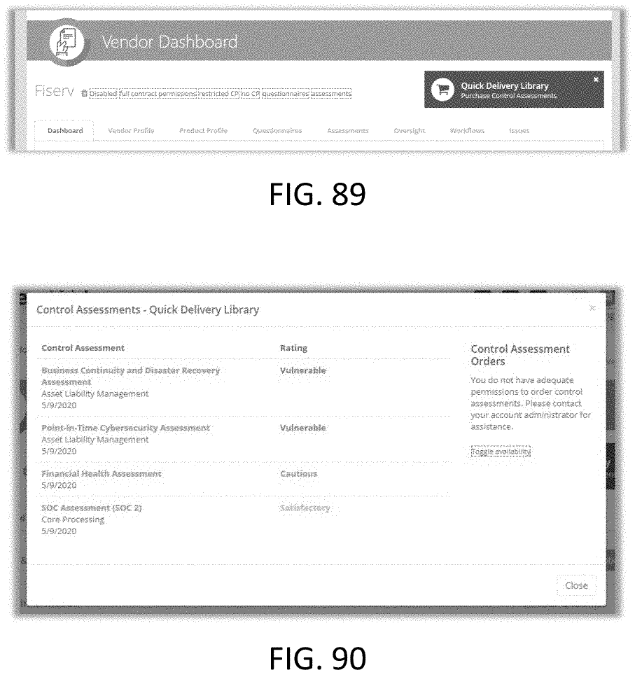

A Vendor Dashboard may include a Quick Delivery Library button. The button may be displayed when there are assessments available to be purchased for the vendor. If there are no assessments for that vendor for purchase, the button may not be displayed. An example Quick Delivery Library widget is shown in FIG. 89.

Selecting the Quick Delivery Library button may open a Control Assessments-Quick Delivery Library modal. The modal may display all assessments available for the vendor. If the user has been provided the capability to order services, the user may do so from the modal. If the user has not been provided with the capability to order services, the Add to Cart button may be hidden. In some embodiments, this widget may function like the Main Dashboard widget. The users may not be provided with the capability to search for vendors from this modal. In some embodiments, capabilities for a quick view of assessments available for purchase for this vendor may be provided. An example Control Assessments Modal widget is provided in FIG. 90.

Exchange—Place an Order

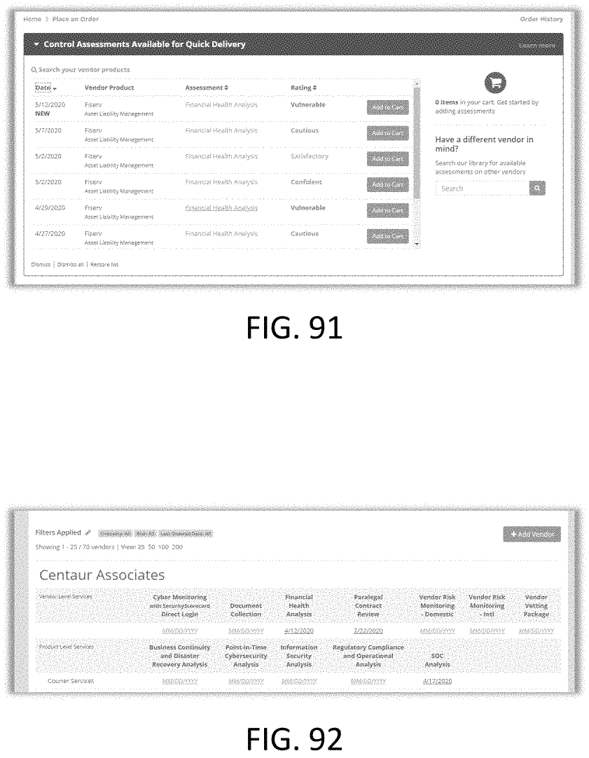

Place an Order page may include a Control Assessments Available for Quick Delivery widget. In some embodiments, the widget may function the same way as it does on the Main Dashboard. The user will provided with the capabilities to order specific assessments and search for vendor products. Only users that have been provided the capabilities to manage order services may access the Place an Order page. All users may be provided with the capabilities to order from the widget. An example Place an Order Page-Control Assessments widget is shown in FIG. 91.

The Place an Order page may provide a user with the capabilities to order non-contracted services. All services offered may be displayed as the default view. An example Place an Order-Ability to Order All Services widget is shown in FIG. 92.

Exchange—Order History

When assessments are completed, the assessment may be delivered/displayed to the Order History page and to Document Storage. When an assessment is delivered for a vendor product that is NOT in the client's vendor product list, the assessment may only be delivered to the Order History page. The assessment may NOT be delivered to Document Storage. In some embodiments, Document Storage may only contain vendor products that are in a client's vendor product list. If the client adds this vendor product to their list at a later time, the assessment may then be moved to Document Storage as well.

### Exemplary Network Environment and Computing Device

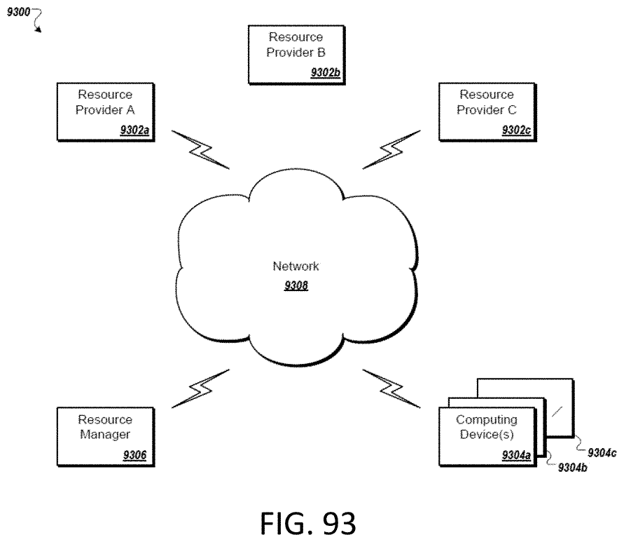

FIG. 93 shows an illustrative network environment 9300 for use in the methods and systems described herein. In brief overview, referring now to FIG. 93, a block diagram of an exemplary cloud computing environment 9300 is shown and described. The cloud computing environment 9300 may include one or more resource providers 9302a, 9302b, 9302c (collectively, 9302). Each resource provider 9302 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 9302 may be connected to any other resource provider 9302 in the cloud computing environment 9300. In some implementations, the resource providers 9302 may be connected over a computer network 9308. Each resource provider 9302 may be connected to one or more computing device 9304a, 9304b, 9304c (collectively, 9304), over the computer network 9308.

The cloud computing environment 9300 may include a resource manager 9306. The resource manager 9306 may be connected to the resource providers 9302 and the computing devices 9304 over the computer network 9308. In some implementations, the resource manager 9306 may facilitate the provision of computing resources by one or more resource providers 9302 to one or more computing devices 9304. The resource manager 9306 may receive a request for a computing resource from a particular computing device 9304. The resource manager 9306 may identify one or more resource providers 9302 capable of providing the computing resource requested by the computing device 9304. The resource manager 9306 may select a resource provider 9302 to provide the computing resource. The resource manager 9306 may facilitate a connection between the resource provider 9302 and a particular computing device 9304. In some implementations, the resource manager 9306 may establish a connection between a particular resource provider 9302 and a particular computing device 9304. In some implementations, the resource manager 9306 may redirect a particular computing device 9304 to a particular resource provider 9302 with the requested computing resource.

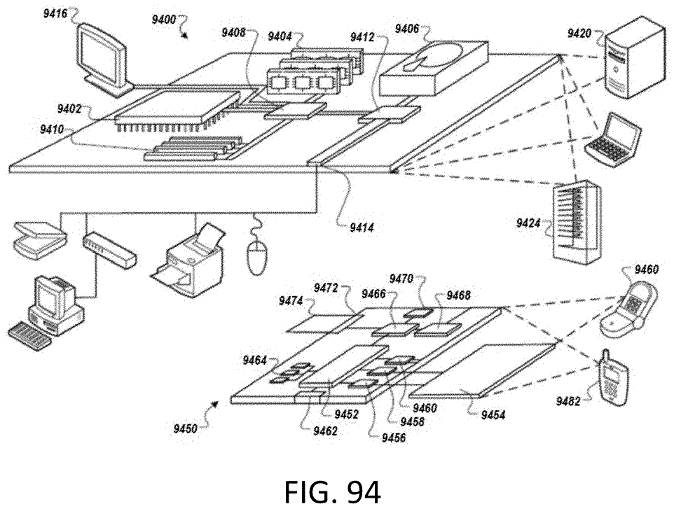

FIG. 94 shows an example of a computing device 9400 and a mobile computing device 9450 that can be used in the methods and systems described in this disclosure. The computing device 9400 is intended to represent various forms of digital computers, such as laptops, desktops, workstations, personal digital assistants, servers, blade servers, mainframes, and other appropriate computers. The mobile computing device 9450 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 9400 includes a processor 9402, a memory 9404, a storage device 9406, a high-speed interface 9408 connecting to the memory 9404 and multiple high-speed expansion ports 9410, and a low-speed interface 9412 connecting to a low-speed expansion port 9414 and the storage device 9406. Each of the processor 9402, the memory 9404, the storage device 9406, the high-speed interface 9408, the high-speed expansion ports 9410, and the low-speed interface 9412, are interconnected using various busses, and may be mounted on a common motherboard or in other manners as appropriate. The processor 9402 can process instructions for execution within the computing device 9400, including instructions stored in the memory 9404 or on the storage device 9406 to display graphical information for a GUI on an external input/output device, such as a display 9416 coupled to the high-speed interface 9408. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 9404 stores information within the computing device 9400. In some implementations, the memory 9404 is a volatile memory unit or units. In some implementations, the memory 9404 is a non-volatile memory unit or units. The memory 9404 may also be another form of computer-readable medium, such as a magnetic or optical disk.

The storage device 9406 is capable of providing mass storage for the computing device 9400. In some implementations, the storage device 9406 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 9402), perform one or more methods, such as those described above. The instructions can also be stored by one or more storage devices such as computer- or machine-readable mediums (for example, the memory 9404, the storage device 9406, or memory on the processor 9402).

The high-speed interface 9408 manages bandwidth-intensive operations for the computing device 9400, while the low-speed interface 9412 manages lower bandwidth-intensive operations. Such allocation of functions is an example only. In some implementations, the high-speed interface 9408 is coupled to the memory 9404, the display 9416 (e.g., through a graphics processor or accelerator), and to the high-speed expansion ports 9410, which may accept various expansion cards (not shown). In the implementation, the low-speed interface 9412 is coupled to the storage device 9406 and the low-speed expansion port 9414. The low-speed expansion port 9414, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 9400 may be implemented in a number of different forms, as shown in the figure. For example, it may be implemented as a standard server 9420, or multiple times in a group of such servers. In addition, it may be implemented in a personal computer such as a laptop computer 9422. It may also be implemented as part of a rack server system 9424. Alternatively, components from the computing device 9400 may be combined with other components in a mobile device (not shown), such as a mobile computing device 9450. Each of such devices may contain one or more of the computing device 9400 and the mobile computing device 9450, and an entire system may be made up of multiple computing devices communicating with each other.

The mobile computing device 9450 includes a processor 9452, a memory 9464, an input/output device such as a display 9454, a communication interface 9466, and a transceiver 9468, among other components. The mobile computing device 9450 may also be provided with a storage device, such as a micro-drive or other device, to provide additional storage. Each of the processor 9452, the memory 9464, the display 9454, the communication interface 9466, and the transceiver 9468, are interconnected using various buses, and several of the components may be mounted on a common motherboard or in other manners as appropriate.

The processor 9452 can execute instructions within the mobile computing device 9450, including instructions stored in the memory 9464. The processor 9452 may be implemented as a chipset of chips that include separate and multiple analog and digital processors. The processor 9452 may provide, for example, for coordination of the other components of the mobile computing device 9450, such as control of user interfaces, applications run by the mobile computing device 9450, and wireless communication by the mobile computing device 9450.

The processor 9452 may communicate with a user through a control interface 9458 and a display interface 9456 coupled to the display 9454. The display 9454 may be, for example, a TFT (Thin-Film-Transistor Liquid Crystal Display) display or an OLED (Organic Light Emitting Diode) display, or other appropriate display technology. The display interface 9456 may comprise appropriate circuitry for driving the display 9454 to present graphical and other information to a user. The control interface 9458 may receive commands from a user and convert them for submission to the processor 9452. In addition, an external interface 9462 may provide communication with the processor 9452, so as to enable near area communication of the mobile computing device 9450 with other devices. The external interface 9462 may provide, for example, for wired communication in some implementations, or for wireless communication in other implementations, and multiple interfaces may also be used.

The memory 9464 stores information within the mobile computing device 9450. The memory 9464 can be implemented as one or more of a computer-readable medium or media, a volatile memory unit or units, or a non-volatile memory unit or units. An expansion memory 9474 may also be provided and connected to the mobile computing device 9450 through an expansion interface 9472, which may include, for example, a SIMM (Single In Line Memory Module) card interface. The expansion memory 9474 may provide extra storage space for the mobile computing device 9450, or may also store applications or other information for the mobile computing device 9450. Specifically, the expansion memory 9474 may include instructions to carry out or supplement the processes described above, and may include secure information also. Thus, for example, the expansion memory 9474 may be provided as a security module for the mobile computing device 9450, and may be programmed with instructions that permit secure use of the mobile computing device 9450. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 9452), perform one or more methods, such as those described above. The instructions can also be stored by one or more storage devices, such as one or more computer- or machine-readable mediums (for example, the memory 9464, the expansion memory 9474, or memory on the processor 9452). In some implementations, the instructions can be received in a propagated signal, for example, over the transceiver 9468 or the external interface 9462.

The mobile computing device 9450 may communicate wirelessly through the communication interface 9466, which may include digital signal processing circuitry where necessary. The communication interface 9466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 9468 using a radio-frequency. In addition, short-range communication may occur, such as using a Bluetooth®, Wi-Fi™, or other such transceiver (not shown). In addition, a GPS (Global Positioning System) receiver module 9470 may provide additional navigation- and location-related wireless data to the mobile computing device 9450, which may be used as appropriate by applications running on the mobile computing device 9450.

The mobile computing device 9450 may also communicate audibly using an audio codec 9460, which may receive spoken information from a user and convert it to usable digital information. The audio codec 9460 may likewise generate audible sound for a user, such as through a speaker, e.g., in a handset of the mobile computing device 9450. Such sound may include sound from voice telephone calls, may include recorded sound (e.g., voice messages, music files, etc.) and may also include sound generated by applications operating on the mobile computing device 9450.

The mobile computing device 9450 may be implemented in a number of different forms, as shown in the figure. For example, it may be implemented as a cellular telephone 9480. It may also be implemented as part of a smart-phone 9482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A method for managing one or more vendors and/or products, the method comprising the steps of:
causing to display, by a processor of an enterprise system, one or more graphical user interfaces (GUIs) associated with one or more exchange modules,
receiving, by the processor of the enterprise system, a first input from a first client user, the first input comprising instructions to access a create new account GUI;
receiving, by the processor of the enterprise system, data field information related to a first vendor;
updating, in a memory of the enterprise system, vendor and/or product information stored in association with the first vendor, based on the subsequent input;
wherein the exchange module is configured to provide control assessments, manage vendor relationships, and share control assessments with the first vendor's customer base.

2. The method of claim 1, wherein the subsequent input comprises data field information relating to contact details and job descriptions of the first vendor.

3. The method of claim 1, wherein the subsequent input comprises custom data field information related to a request to perform an assessment.

4. The method of claim 1, wherein the subsequent input comprises instructions to create an email document to be sent to one or more clients of the first vendor.

5. The method of claim 1, wherein the subsequent input comprises instructions to download an assessment.

6. The method of claim 1, wherein the first input is received via a graphical user interface widget.

7. The method of claim 1, wherein said first client user has been authorized to access the enterprise system.

8. The method of claim 1, wherein said first vendor client user comprises one member of a network of subscribed clients.

9. The method of claim 1, wherein the data field information related to the first vendor is received via a graphical user interface widget.
